(19) United States
(12) Patent Application Publication
(10) Pub. No.: US 2008/0311503 A1
(43) Pub. Date: Dec. 18, 2008

(54) Toner, method of manufacturing the same, two-component developer, developing device, and image forming apparatus

(75) Inventors: Ayae Nagaoka, Uji-shi (JP); Satoru Ariyoshi, Nara-shi (JP); Tadashi Iwamatsu, Nara-shi (JP); Katsuru Matsumoto, Nara-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 12/213,263

(22) Filed: Jun. 17, 2008

(30) Foreign Application Priority Data
Jun. 18, 2007 (JP) P2007-160626
Apr. 16, 2008 (JP) P2008-107336

(51) Int. Cl. G03G 9/087; G03G 9/09; G03G 9/10

(52) U.S. Cl. 430/110.1; 430/105; 430/137.14

(57) ABSTRACT

A toner composed of small particles excellent in a cleaning property, a transferring property, and charge uniformity is provided as well as a method of manufacturing the toner, and two-component developer, developing device, and image forming apparatus using the toner. The toner contains binder resin and colorant, and includes a particle which has an outline having one or more and three or less bending points in its projection image on a plane. The toner thus contains a non-spherical particle and therefore is caught easily by a cleaning blade as well as coming into point-contact with a to-be-transferred member, therefore being capable of having both of cleaning property and transferring property.

### CROSS-REFERENCE TO RELATED APPLICATION

This application claims priority to Japanese Patent Application Nos. 2007-160626 and 2008-107336, which were filed on Jun. 18, 2007 and Apr. 16, 2008, the contents of which are incorporated herein by reference in its entirety.

### BACKGROUND OF THE INVENTION

1. Field of the Invention

The present invention relates to a toner, a method of manufacturing the toner, two-component developer, and an image forming apparatus.

2. Description of the Related Art

A method of visualizing image information by once converting the image information into an electrostatic latent image is utilized in various fields today through an image forming apparatus employing an electrophotographic system or electrostatic recording system to form an image. For example, an image is formed in a manner that: signal light is emitted to a surface of a charged photoreceptor to form an electrostatic latent image corresponding to image information; to the electrostatic latent image thus formed, a toner of developer is supplied to visualize the electrostatic latent image into a toner image; and the toner image on the surface of the photoreceptor is transferred to a recording medium and further fixed thereto.

Developer for use in the image forming apparatus as above includes one-component developer containing a toner only, and two-component developer containing a toner and a carrier. As a method of manufacturing a toner, the pulverizing method is widely known that toner materials are molten, kneaded, pulverized and classified.

The toner pulverized will, however, have particles with irregular forms and surface structure. Although different more or less depending on a pulverizing property of materials to be used and conditions in a pulverizing step, etc., it is not easy to freely control the particle form and surface structure of the toner to desired degrees. The irregular particle form of the toner leads to a failure of providing the toner with sufficient fluidity even when a fluidizer is added to the toner. And if the fluidizer is added to the toner, the fluidizer will accumulate and be buried in concavities formed in a surface of the toner, thereby causing problems such as temporal decreases in fluidity, a developing property, a transferring property, a cleaning property, etc. Especially for a transferring property, the toner having irregularly shaped particles comes into contact with the photoreceptor at the larger number of points which increase the adherence between the toner and the photoreceptor, with the result that a transferring property tends to be further degraded. When a larger amount of the fluidizer is added so as not to cause the above problems, other problems arise such as generation of black spots on the photoreceptor and in the case of the two-component developer, a decrease in chargeability due to the fluidizer attached to the carrier.

Further, in view of the limitations of pulverizing property and classifying ability with accompanying cost increase, it is difficult to decrease a current width of particle size distribution of the pulverized toner. A limit of the particle size to be decreased for higher image quality is 6 μm from the aspect of yield, productivity, and cost.

In order to overcome those problems of the pulverizing method, there has been proposed the suspension polymerizing method to manufacture a toner. This method is advantageous in manufacturing small toner particles with a narrow particle size distribution. Toner particles obtained by the method are high in sphericity and excellent in a transferring property, but easily cause cleaning defects since a not-transferred toner remaining on the photoreceptor easily goes through a cleaning blade. In order to solve the problems as above, there has been proposed, as a toner excellent in a cleaning property, a toner having particles with their form and surface structures controlled.

For example, Japanese Unexamined Patent Publication JP-A 5-66610 (1993) discloses a non-spherical suspension-polymerized toner having a volume average particle size in the order of 1 μm to 5 μm, which toner is obtained by suspension-polymerizing a monomer composition containing polymerizable monomers in an aqueous medium containing poorly water soluble inorganic compound and anionic surfactant. According to the disclosure, a shape factor of the toner exceeds 1.3. The shape factor indicates a value obtained by dividing a value of BET specific surface area by a value of sphericity-converted specific surface area. The toner particles having a shape factor closer to 1.0 are more spherical.

Further, Japanese Unexamined Patent Publication JP-A 2002-287400 discloses a dry toner having a circularity degree of 0.960 to 1.000 and a surface with a plurality of concavities each of which major axis is 1.0 μm to 5.0 μm measured in its image photographed by a scanning electronic microscope.

Further, Japanese Unexamined Patent Publication JP-A 2005-266200 discloses a toner partially containing a deformed toner which has a projection part near an axis of rotation of a substantially spherical or spindle-shaped base body and which satisfies specific relations between a major axis and a minor axis of the base body and between a major axis and a minor axis of the projection part in a projection view of the toner particles.

Further, Japanese Unexamined Patent Publication JP-A 9-160292 (1997) discloses a toner of single-dispersible nonspherical polymer particles formed of at least two polymer particles.

As a method of defining a shape of toner particle, a method of digitalization using a Fourier coefficient is disclosed in an article written by Takahiko Nishioka et al. “Digitalization of cocoon shape through main component analysis using a Fourier coefficient”, the Journal of Sericultural Science of Japan, Vol. 67, No. 6, pp. 479-484. 1998 Dec.

The toners disclosed in JP-A 5-66610 (1993) and JP-A 2002-287400 are both formed of non-spherical particles which exhibit higher cleaning properties since the toners are more easily caught by cleaning blades in cleaning processes. However, a detailed particle shape of the toner is not defined in JP-A 5-66610 (1993), and it is therefore assumed that the toner particle may have a shape of, for example, ellipse or spindle. Further, in JP-A 2002-287400, the plurality of concavities existing in the toner surface lead to particle surface curvatures different from one area to another. As just described, the surface curvatures of the toner particles are not taken into consideration in JP-A 5-66610 (1993) and JP-A 2002-287400 and therefore, the toners have particles nonuniformly charged, with the result that not-transferred toner is generated due to insufficient charges in the transferring step, possibly causing a decrease in image density or the like trouble.

The toner disclosed in JP-A 2005-266200 has particles with their shapes defined in detail and thus contains a deformed toner which has a projection part near an axis of rotation of a substantially spherical or spindle-shaped base body. Since the projection part of the toner is elongated and frangible from the base body, fine particle toners are easily generated. The fine particle toners are highly charged and attached to a developing roller and a magnetic carrier, thus impairing normal charging. Consequently, a content of the deformed toner based on the entire toner is limited to such a low level as 3% to 10% by number, and the toner particles have uneven cleaning property, transferring property, and developing property.

The toner disclosed in JP-A 9-160292 (1997) has particles with their shapes not defined in detail, including small spherical particles having an average particle size of 1 μm to 2 μm and large spherical particles having an average particle size of 5 μm to 10 μm, all of which particles are integrally joined. Although it is not mentioned how much surfaces of joined particles are overlapped with each other, the small spherical particles having an average particle size of 1 μm to 2 μm have small contact surface areas and since the overlapped surface area needs to be large for joining the particles with such intensity that the particles are not separated during use, projection parts will be very small. As a result, a cleaning failure easily occurs. Moreover, the large sphere and the small sphere are so different from each other in curvature radius, resulting in uneven surface charging property and developing property.

### SUMMARY OF THE INVENTION

The invention has been completed in view of the problems as above, and an object of the invention is to provide a toner composed of small particles excellent in a cleaning property, a transferring property, and charge uniformity, as well as to provide a method of manufacturing the toner and provide two-component developer, developing device, and image forming apparatus using the toner.

The invention provides a toner containing at least binder resin and colorant, the toner comprising a particle which has an outline having one or more and three or less bending points in its projection image on a plane.

According to the invention, the toner contains at least binder resin and colorant, and when a particle of the toner is projected on a plane, one or more and three or less bending points are found in an outline of a projection image of the particle projected on the plane.

The toner thus contains a non-spherical particle and therefore is caught easily by a cleaning blade as well as coming into point-contact with a to-be-transferred member, therefore being capable of achieving a good balance between cleaning property and transferring property.

Further, in the invention, it is preferable that 0.35≦(S₂/S₁)+(S₃/S₁) is satisfied where S₁, S₂, and S₃ represent areas in descending order, the areas being each enclosed by a straight line connecting the bending points and the outline of the projection image of the particle projected on the plane.

According to the invention, (S₂/S₁)+(S₃/S₁) is 0.35 or more, with the result that the toner is more efficiently caught by a cleaning blade, thus exhibiting a higher cleaning property. Moreover, curvature radiuses of the particles having the bending points are mutually approximate, resulting in a toner having uniform surface chargeability and excellent developing property and transferring property.

Further, in the invention, it is preferable that the toner contains 60% by number or more of the particle which has the outline having one or more and three or less bending points in its projection image projected on the plane.

According to the invention, the toner contains 60% by number or more of the deformed particle which has the outline having one or more and three or less bending points in its projection image projected on the plane, thus allowing for a sufficient effect of combination of cleaning property and transferring property.

Further, in the invention, it is preferable that coefficients a₀, a₂, and b₂ in the following expression (1) satisfy 0.15≦a₀⁻¹(a₂²+b₂²)^{1/2}≦0.38 in a Fourier series expansion of a waveform of plots of distance f(x)(μm) from a center of gravity of the outline to the outline at a given angle x (rad) from the center of gravity of the outline:

f(x)=a₀/2+Σ(aₙ cos [nx]+bₙ sin [nx]) (1)

According to the invention, it appears that two fine particles come into contact with each other in an aggregating process to thereby form a toner particle having such a cocoon shape satisfying the above condition as two fine particles symmetrically joined. Accordingly, two bending points exist in the outline of the toner particle so that the toner can be easily caught by the cleaning blade as well as coming into point-contact with the to-be-transferred member, therefore allowing for combination of cleaning property and transferring property. Further, the toner particles have a uniform curvature and therefore have surfaces uniformly charged.

By defining a relation of the coefficients as a₀⁻¹(a₂²+b₂²)^{1/2}, the form can be defined even when the distance from the center of gravity to the outline is plotted from a point at a given angle.

Further, in the invention, it is preferable that the coefficients a₀ and a₂ in the above expression (1) satisfy 0.15≦a₂/a₀≦0.35 in a Fourier series expansion of a waveform of plots of distance f(x)(μm) from the center of gravity of the outline to the outline at a given angle x (rad) where a distance from the center of gravity of the outline to the outline is the longest at zero angle (rad).

According to the invention, a particle shape satisfying the above condition is considered to be formed in the following process. In the process where fine particles in aqueous slurry are gradually aggregating, the aggregating speed is increased so that aggregating particles come into contact with each other. The aggregating speed is increased by controlling aggregating-agent addition, a temperature of the aqueous slurry, and shear force generated by a rotor or the like device. Upon contacting, the aggregating particles at temperatures equal to or higher than a glass transition temperature of the resin are fused each other to eventually form smooth-surfaced particles having no particle interfaces.

In the above case, it appears that two fine aggregating particles come into contact with each other to thereby form a toner particle having such a cocoon shape as two fine particles symmetrically joined. Accordingly, two bending points exist in the outline of the toner particle so that the toner can be easily caught by the cleaning blade as well as coming into point-contact with the to-be-transferred member, therefore allowing for combination of cleaning property and transferring property. Further, the toner particles have a uniform curvature and therefore have surfaces uniformly charged.

Further, in the invention, it is preferable that coefficients a₀, a₃, and b₃ in the above expression (1) satisfy 0.08≦a₀⁻¹(a₃²+b₃²)^{1/2}≦0.22 in a Fourier series expansion of a waveform of plots of distance f(x)(μm) from a center of gravity of the outline to the outline at a given angle x (rad) from the center of gravity of the outline.

According to the invention, it appears that three or four fine particles come into contact with each other in the aggregating process to thereby form a toner particle having a substantial triangle or tetrapod shape satisfying the above condition. Accordingly, three bending points exist in the outline of the toner particle so that the toner can be easily caught by the cleaning blade as well as coming into point-contact with the to-be-transferred member, therefore allowing for combination of cleaning property and transferring property. Further, the toner particles have a uniform curvature and therefore have surfaces uniformly charged.

By defining a relation of the coefficients as a₀⁻¹(a₃²+b₃²)^{1/2}, the form can be defined even when the distance from the center of gravity to the outline is plotted from a point at a given angle.

Further, in the invention, it is preferable that the coefficients a₀ and a₃ in the above expression (1) satisfy 0.08≦a₃/a₀≦0.20 in a Fourier series expansion of a waveform of plots of distance f(x)(μm) from the center of gravity of the outline to the outline at a given angle x (rad) where a distance from the center of gravity of the outline to the outline is the longest at zero angle (rad).

According to the invention, a particle shape satisfying the above condition is considered to be formed by increasing aggregating force with a larger amount of the aggregating agent than its amount for forming the above cocoon-shaped toner particle, thereby joining three or four fine aggregating particles to form a toner particle having a substantial triangle or tetrapod shape. When the toner particles having the above shapes are each projected on a plane, the outlines of such projection images are the same and contain three bending points. The toners having these particles shaped as above can be easily caught by the cleaning blade as well as coming into point-contact with the to-be-transferred member, therefore allowing for combination of cleaning property and transferring property. Further, the toner particles have a uniform curvature and therefore have surfaces uniformly charged.

Further, in the invention, it is preferable that coefficients a₀, a₂, and b₃ in the above expression (1) satisfy 0.10≦a₀⁻¹(a₂²+b₃²)^{1/2}≦0.38 in a Fourier series expansion of a waveform of plots of distance f(x)(μm) from a center of gravity of the outline to the outline at a given angle x (rad) from the center of gravity of the outline.

According to the invention, it appears that one of the two bending points of fine particles joined in the aggregating process is flattened, thereby forming a toner particle having such a shape satisfying the above condition that one bending point remains at center thereof. The toner having a particle shaped as above can be easily caught by the cleaning blade as well as coming into point-contact with the to-be-transferred member, therefore allowing for combination of cleaning property and transferring property.

By defining a relation of the coefficients as a₀⁻¹(a₂²+b₃²)^{1/2}, the form can be defined even when not the distance from an intersection of a major axis with a minor axis to the outline but the distance from the center of gravity to the outline is plotted.

Further, in the invention, it is preferable that coefficients a₀, a₂, and b₁ in the above expression (1) satisfy 0.05≦a₂/a₀≦0.15 and 0.25≦(a₂/a₀+b₁/a₀)≦0.50 in a Fourier series expansion of a waveform of plots of distance f(x)(μm) from the center of gravity of the outline to the outline at a given angle x (rad) where a distance from an intersection of a major axis with a minor axis of the outline to the outline is the longest at zero angle (rad).

According to the invention, a particle shape satisfying the above condition is considered to be formed by increasing the shear force and centrifugal force with the larger rotational speed of a rotor/stator than its speed for forming the above cocoon-shaped toner particle, thereby flattening one of the two bending points of joined fine particles aggregating, and thus resulting in a toner particle having one bending point remaining at center thereof. The toner having a particle shaped as above can be easily caught by the cleaning blade as well as coming into point-contact with the to-be-transferred member, therefore allowing for combination of cleaning property and transferring property. Further, the toner particles have a uniform curvature and therefore have surfaces uniformly charged.

Further, in the invention, it is preferable that coefficients a₀, a₂, and a₃ in the above expression (1) satisfy 0.10≦a₀⁻¹(a₂²+a₃²)^{1/2}≦0.38 in a Fourier series expansion of a waveform of plots of distance f(x)(μm) from a center of gravity of the outline to the outline at a given angle x (rad) from the center of gravity of the outline.

According to the invention, it appears that fine particles different in size come into contact with each other and are thus joined in the aggregating process, thereby forming a calabash-shaped toner particle having a shape satisfying the above condition. The toner thus has a particle with its outline including two bending points as in the case of the cocoon-shaped toner, and can be therefore easily caught by the cleaning blade as well as coming into point-contact with the to-be-transferred member, which allows for combination of cleaning property and transferring property.

Further, in the invention, it is preferable that coefficients a₀, a₂, and b₄ in the above expression (1) satisfy 0.09≦a₀⁻¹(a₂²+b₄²)^{1/2}≦0.38 in a Fourier series expansion of a waveform of plots of distance f(x)(μm) from a center of gravity of the outline to the outline at a given angle x (rad) from the center of gravity of the outline.

According to the invention, it appears that fine particles asymmetrically come into contact with each other and are thus joined in the aggregating process, thereby forming a peanut-shaped toner particle having a shape satisfying the above condition. The toner thus has a particle with its outline including two bending points as in the case of the cocoon-shaped toner, and can be therefore easily caught by the cleaning blade as well as coming into point-contact with the to-be-transferred member, which allows for combination of cleaning property and transferring property.

Further, in the invention, it is preferable that the toner is formed of aggregated particles into which at least fine resin particles and fine colorant particles aggregate, and has a volume average particle size of 3 μm or more and 10 μm or less.

According to the invention, a shape control becomes easy by aggregating the fine particles, and high definition and high resolution images can be formed by setting the volume average particle size to be 3 μm or more and 10 μm or less.

Further, in the invention, it is preferable that the toner is formed of aggregated particles into which fine coloring resin particles containing at least colorant and binder resin aggregate, and has a volume average particle size of 3 μm or more and 10 μm or less.

Toner materials containing at least colorant and binder resin are molten and kneaded to form fine particles, thereby allowing for an increase in pigment dispersibility and thus increases in color development and saturation in addition to an effect of the aggregated particles into which at least fine resin particles and fine coloring particles aggregate.

Further, in the invention, it is preferable that the fine coloring resin particles have a volume average particle size of 0.2 μm or more 3.0 μm or less.

According to the invention, the fine resin particles of the above size are aggregated, with the result that the toner can be provided with favorable properties such as uniformity in shape, a smaller particle size, and a narrower particle size distribution.

Further, in the invention, it is preferable that the fine coloring resin particles are obtained by a high-pressure homogenizer method.

According to the invention, the fine coloring resin particles are obtained by a high-pressure homogenizer method, thus allowing for fine coloring resin particles having small sizes and a narrow particle size distribution.

The invention provides a method of manufacturing the above toner, comprising the steps of:

preparing aqueous slurry having fine coloring resin particles dispersed therein by a high-pressure homogenizer method, the fine coloring resin particles containing the above colorant and the above binder resin; and

aggregating the fine coloring resin particles in the aqueous slurry.

According to the invention, aqueous slurry is prepared in which fine coloring resin particles containing the above colorant and the above binder resin are dispersed by a high-pressure homogenizer method, and then the fine coloring resin particles are aggregated in the aqueous slurry, thereby forming a toner.

By so doing, a non-spherical toner particle having a specific shape can be efficiently prepared, with the result that the above toner can be easily obtained, thus allowing for even uniform charges in addition to the combination of cleaning property and transferring property.

Further, in the invention, it is preferable that the fine coloring resin particles in the aqueous slurry aggregate in a granulating device including an agitating container storing the aqueous slurry and an agitating part being disposed inside the agitating container and agitating the aqueous slurry.

According to the invention, a granulating device includes: an agitating container for storing the aqueous slurry; and an agitating part (of rotor/stator type) which is disposed inside the agitating container and agitates the aqueous slurry, and by using the granulating device, the fine coloring resin particles in the aqueous slurry aggregate.

In the granulating device as above, the fine resin particles collide each other by kinetic energy of agitating force of a rotor, thereby forming the aggregated particles while excessive aggregation is prevented by shear force generated by a gap between a rotor rotating at high rate and a stator. That is to say, a toner of aggregated particles exhibiting a narrow particle size distribution can be obtained by controlling balance between formation of aggregated particles through the collision and restraint on an upper limit of a particle size with shear force.

Further, the invention provides a two-component developer containing the above toner and a carrier.

According to the invention, a two-component developer contains the above toner and a carrier, thus allowing for combination of cleaning property and transferring property so that a high-quality image free from image defects can be formed.

Further, the invention provides a developing device performing development by use of developer containing the toner.

According to the invention, a developing device performs development by use of developer containing the above toner or the above two-component developer, with the result that a high-quality image free from image defects can be formed on a photoreceptor.

Further, the invention provides an image forming apparatus having the developing device.

According to the invention, the image forming apparatus has the above developing device, thus allowing for formation of a high-quality image free from image defects.

### BRIEF DESCRIPTION OF THE DRAWINGS

Other and further objects, features, and advantages of the invention will be more explicit from the following detailed description taken with reference to the drawings wherein:

FIGS. 1A and 1B are views each showing an example of a toner particle having two bending points;

FIGS. 2A and 2B are views each showing an example of a toner particle having three bending points;

FIG. 3 is a schematic view showing an outline of projection image of toner particle having two bending points;

FIG. 4 is a schematic view showing an outline of projection image of toner particle having three bending points;

FIG. 5 is a schematic view showing an outline of projection image of toner particle having one bending point;

FIG. 6 is a schematic view showing an outline of projection image of toner particle having two bending points;

FIG. 7 is a schematic view showing an outline of projection image of toner particle having two bending points;

FIG. 8 is a view showing an SEM photograph image of cocoon-shape toner particle having two bending points;

FIG. 9 is a projection view obtained by defining an outline of the photograph image of FIG. 8;

FIG. 10 is a 360-degree radiation view equally divided from its center into 128 parts;

FIG. 11 is a view obtained by overlapping a coordinate of the center of gravity of the outline of the projection view of FIG. 9 with the center of the radiation view of FIG. 10;

FIG. 12 is a flowchart showing a procedure of a method of manufacturing the toner according to an embodiment of the invention;

FIG. 13 is a sectional view schematically showing a configuration of an image forming apparatus according to an embodiment of the invention;

FIG. 14 is a sectional view schematically showing a configuration of a developing device according to an embodiment of the invention;

FIG. 15 is a view showing an SEM photograph image of toner particles of Example 5;

FIG. 16 is a projection view obtained by defining an outline of a photograph image of FIG. 15; and

FIG. 17 is a view overlapping a coordinate of the center of gravity of the outline of the projection view of FIG. 16 with the center of the radiation view of FIG. 10.

### DETAILED DESCRIPTION

Now referring to the drawings, preferred embodiments of the invention are described below.

A toner according to an embodiment of the invention (which may be hereinafter referred to simply as “toner”) contains at least binder resin and colorant and has a particle which has an outline having one or more and three or less bending points in its projection image on a plane. Herein, the “bending point” means an apex of a concavely curved portion of the outline.

Accordingly, the toner has a particle of non-spherical shape and is thus caught easily by a cleaning blade as well as coming into point-contact with a to-be-transferred member, therefore being capable of having both of cleaning property and transferring property.

In the present embodiment, 0.35≦(S₂/S₁)+(S₃/S₁) is preferably satisfied where S₁, S₂, and S₃ represent areas in descending order, which areas are each enclosed by a straight line (parting line) connecting bending points and the outline of the projection image of the particle projected on the plane. When (S₂/S₁)+(S₃/S₁) is smaller than 0.35, a contact area of the particles having the bending points is too small to retain strength. At the same time, a projection part is small, and a cleaning failure easily occurs. Moreover, the particles having the bending points are so different from each other in curvature radius, resulting in uneven surface charging property and developing property.

The areas S₁, S₂, and S₃ enclosed by the parting lines and the outlines in the projection images of the toner particles can be determined as follows.

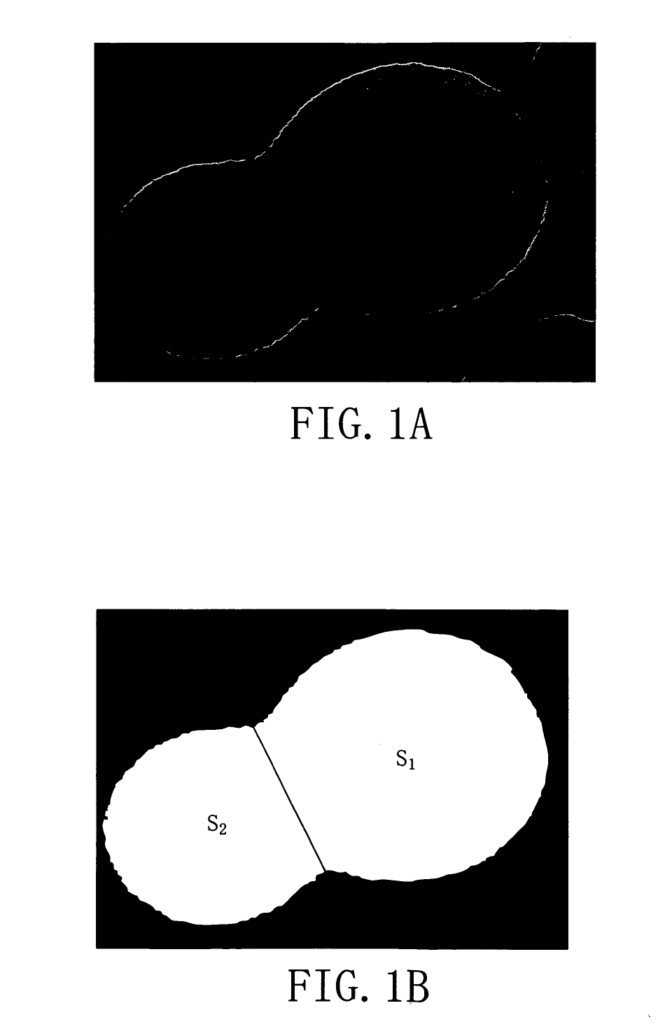

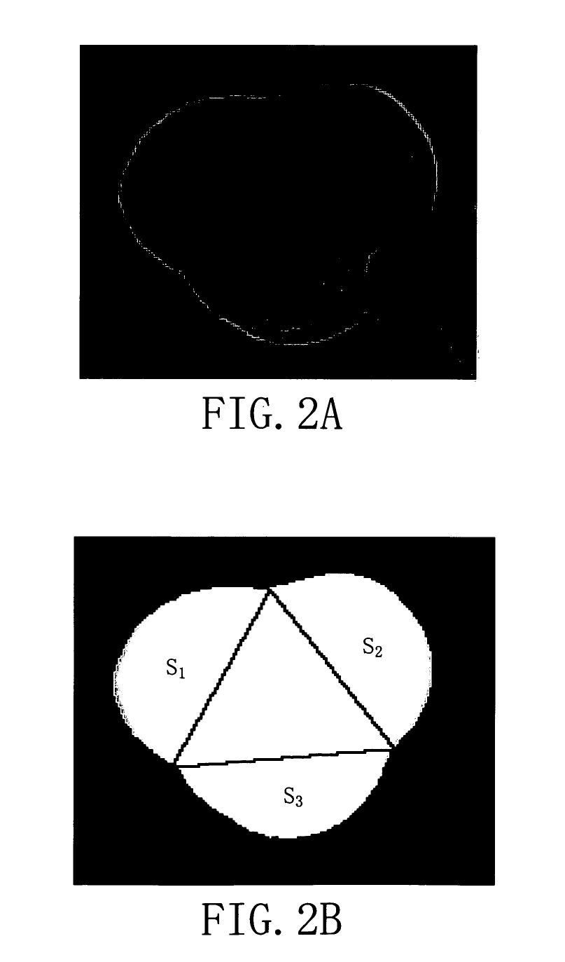

FIGS. 1A and 1B are views each showing an example of a toner particle having two bending points. FIGS. 2A and 2B are views each showing an example of a toner particle having three bending points.

FIG. 1A is a view showing an SEM photograph image of a toner particle. FIG. 1B is a view of the outline partitioned by the parting line into two parts in the projection image obtained by defining an outline of the photograph image of FIG. 1A. Of the areas enclosed by the parting line connecting the bending points and the outline, a larger one is denoted by S₁ while a smaller one is denoted by S₂. In this case, S₃ is zero.

FIG. 2A is a view showing an SEM photograph image of a toner particle. FIG. 2B is a view of the outline partitioned by the parting line into four parts in the projection image obtained by defining an outline of the photograph image of FIG. 2A. The areas enclosed by the parting line connecting the bending points and the outline are denoted by S₁, S₂, and S₃ in descending order from largest to smallest.

As shown in FIGS. 1A and 2A, a toner particle is, for example, photographed by an electron microscope such as a scanning electron microscope (abbreviated as SEM). In an obtained photograph image of the toner particle, an outline is defined by using image analysis software and partitioned by a straight line connecting the bending points in a projection view as shown in FIGS. 1B and 2B. And through further analysis of the projection view, the respective areas are determined.

Assuming that an entire area of the particle is 1, S₁ is 0.636 and S₂ is 0.364 in FIG. 1B and thus, S₂/S₁ is 0.572. Since S₃ is zero, (S₂/S₁)+(S₃/S₁)=0.572 (≧0.35). Further, SI is 0.250, S₂ is 0.248, and S₃ is 0.201 in FIG. 2B. Accordingly, S₂/S₁ is 0.992 and S₃/S₁ is 0.804. Therefore (S₂/S₁)+(S₃/S₁)=1.796 (≧0.35).

The toner contains preferably 60% by number or more, more preferably 80% by number or more, still more preferably 90% by number or more of the particle which has the outline having one or more and three or less bending points in its projection image projected on the plane. In the case where the above content of the toner particle is less than 60% by number, there exists a toner having toner particles which are each spherical or provided with the larger number of bending points, causing a failure to exert sufficient effect of combination of cleaning property and transferring property.

The projection image as above is obtained by defining an outline of an image (SEM image) photographed by a scanning electronic microscope through image processing.

It is preferable that coefficients a₀, a₂, and b₂ in the expression (1) satisfy 0.15≦a₀⁻¹(a₂²+b₂²)^{1/2}≦0.38 in a Fourier series expansion of a waveform of plots of distance f(x)(μm) from a center of gravity of the outline to the outline at a given angle x (rad) from the center of gravity of the defined outline.

It appears that two fine particles come into contact with each other in an aggregating process to thereby form a toner particle having such a cocoon shape satisfying the above condition as two fine particles symmetrically joined. Accordingly, two bending points exist in the outline of the toner particle so that the toner can be easily caught by the cleaning blade as well as coming into point-contact with the to-be-transferred member, therefore allowing for combination of cleaning property and transferring property. Further, the toner particles have a uniform curvature and therefore have surfaces uniformly charged. By defining a relation of the coefficients as a₀⁻¹(a₂²+b₂²)^{1/2}, the form can be defined even when the distance from the center of gravity to the outline is plotted from a point at a given angle.

When the value a₀⁻¹(a₂²+b₂²)^{1/2} is less than 0.15, a dent is so small that no effect of enhanced cleaning property can be exerted. When the value a₀⁻¹(a₂²+b₂²)^{1/2} is more than 0.38, a dent is so large that the collapse probability due to external force becomes higher, resulting in a failure to exert effects of a transferring property and charge uniformity.

It is preferable that coefficients a₀ and a₂ in the expression (1) satisfy 0.15≦a₂/a₀≦0.35 in a Fourier series expansion of a waveform of plots of distance f(x)(μm) from a center of gravity of the outline to the outline at a given angle x (rad) where a distance from the center of gravity of the defined outline to the outline is the longest at zero angle (rad).

When the value a₂/a₀ is less than 0.15, a dent is so small that no effect of enhanced cleaning property can be exerted. When the value a₂/a₀ is more than 0.35, a dent is so large that the collapse probability due to external force becomes higher, resulting in a failure to exert effects of a transferring property and charge uniformity.

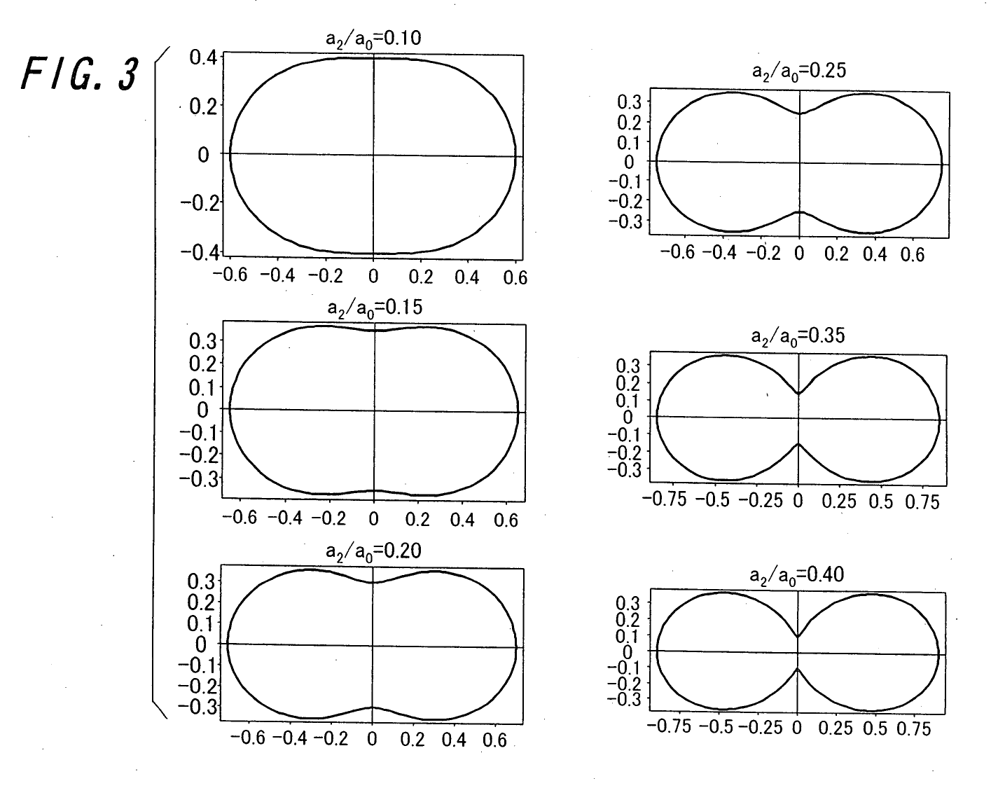

FIG. 3 is a schematic view showing an outline of projection image of toner particle having two bending points. As shown in FIG. 3, an outline form of toner particle having two bending points changes as the fraction a₂/a₀ of Fourier coefficient changes. The toner having two bending points with the Fourier coefficient a₂/a₀ of 0.15 or more and 0.35 or less is preferably caught by a cleaning blade as well as coming into point-contact with a to-be-transferred member, therefore being capable of having both of cleaning property and transferring property. Further, the toner particles have a uniform curvature and therefore have surfaces uniformly charged. When the Fourier coefficient a₂/a₀ is less than 0.15, a dent is too small to exert an effect of enhanced cleaning property. When the Fourier coefficient a₂/a₀ is more than 0.35, a dent is too large to exert effects of a transferring property, charge uniformity, etc. since the collapse probability due to external force becomes higher.

It is preferable that coefficients a₀, a₃, and b₃ in the expression (1) satisfy 0.08≦a₀⁻¹(a₃²+b₃²)^{1/2}≦0.22 in a Fourier series expansion of a waveform of plots of distance f(x)(μm) from a center of gravity of the outline to the outline at a given angle x (rad) from the center of gravity of the defined outline.

It appears that three or four fine particles come into contact with each other in the aggregating process to thereby form a toner particle having a substantial triangle or tetrapod shape satisfying the above condition. Accordingly, three bending points exist in the outline of the toner particle so that the toner can be easily caught by the cleaning blade as well as coming into point-contact with the to-be-transferred member, therefore allowing for combination of cleaning property and transferring property. Further, the toner particles have a uniform curvature and therefore have surfaces uniformly charged. By defining a relation of the coefficients as a₀⁻¹(a₃²+b₃²)^{1/2}, the form can be defined even when the distance from the center of gravity to the outline is plotted from a point at a given angle.

When the value a₀⁻¹(a₃²+b₃²)^{1/2} is less than 0.08, a dent is so small that no effect of enhanced cleaning property can be exerted. When the value a₀⁻¹(a₃²+b₃²)^{1/2} is more than 0.22, a dent is so large that the collapse probability due to external force becomes higher, resulting in a failure to exert effects of a transferring property and charge uniformity.

It is preferable that coefficients a₀ and a₃ in the expression (1) satisfy 0.08≦a₃/a₀≦0.20 in a Fourier series expansion of a waveform of plots of distance f(x)(μm) from a center of gravity of the outline to the outline at a given angle x (rad) where a distance from the center of gravity of the defined outline to the outline is the longest at zero angle (rad).

When the value a₃/a₀ is less than 0.08, a dent is so small that no effect of enhanced cleaning property can be exerted. When the value a₃/a₀ is more than 0.20, a dent is so large that the collapse probability due to external force becomes higher, resulting in a failure to exert effects of a transferring property and charge uniformity.

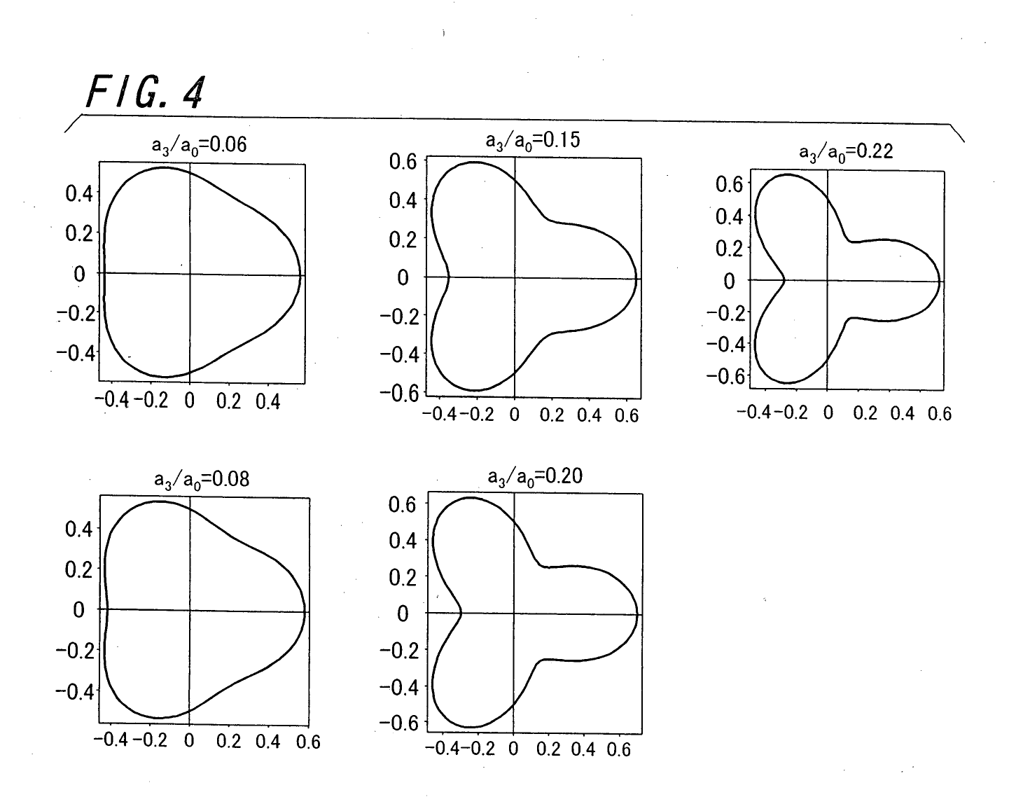

FIG. 4 is a schematic view showing an outline of projection image of toner particle having three bending points. As shown in FIG. 4, an outline form of toner particle having three bending points changes as the fraction a₃/a₀ of Fourier coefficient changes. The toner having three bending points with the Fourier coefficient a₃/a₀ of 0.08 or more and 0.20 or less is preferably caught by a cleaning blade as well as coming into point-contact with a to-be-transferred member, therefore being capable of having both of cleaning property and transferring property. Further, the toner particles have a uniform curvature and therefore have surfaces uniformly charged. When the Fourier coefficient a₃/a₀ is less than 0.08, a dent is too small to exert an effect of enhanced cleaning property. When the Fourier coefficient a₃/a₀ is more than 0.20, a dent is too large to exert effects of a transferring property, charge uniformity, etc. since the collapse probability due to external force becomes higher.

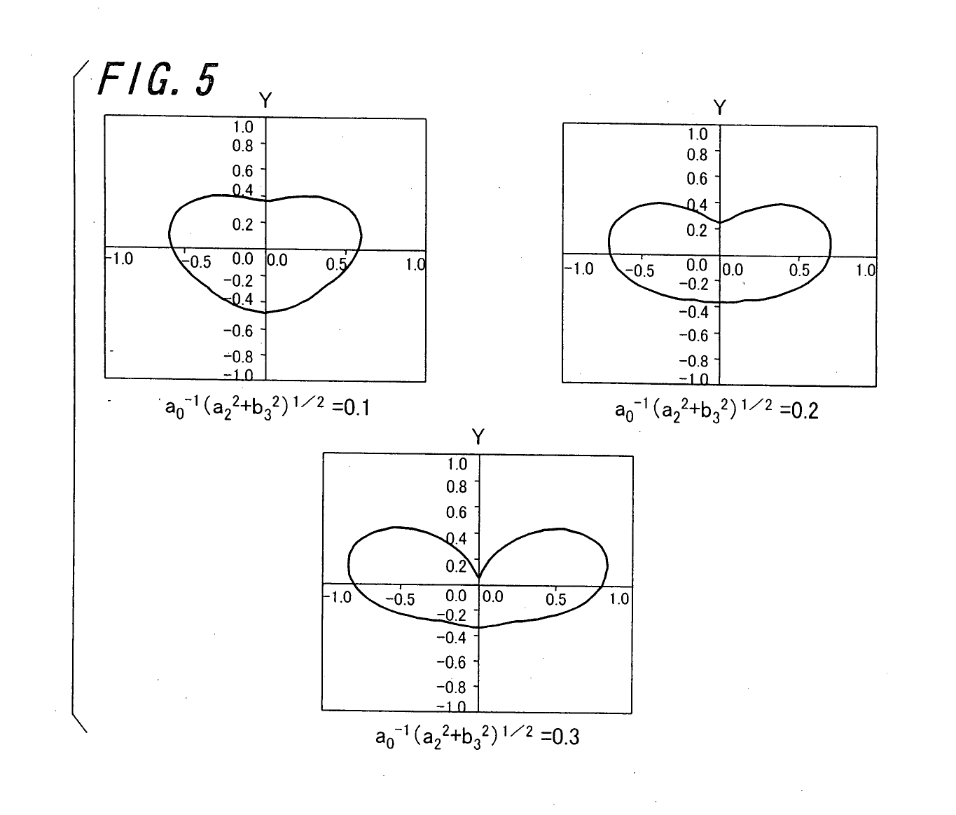

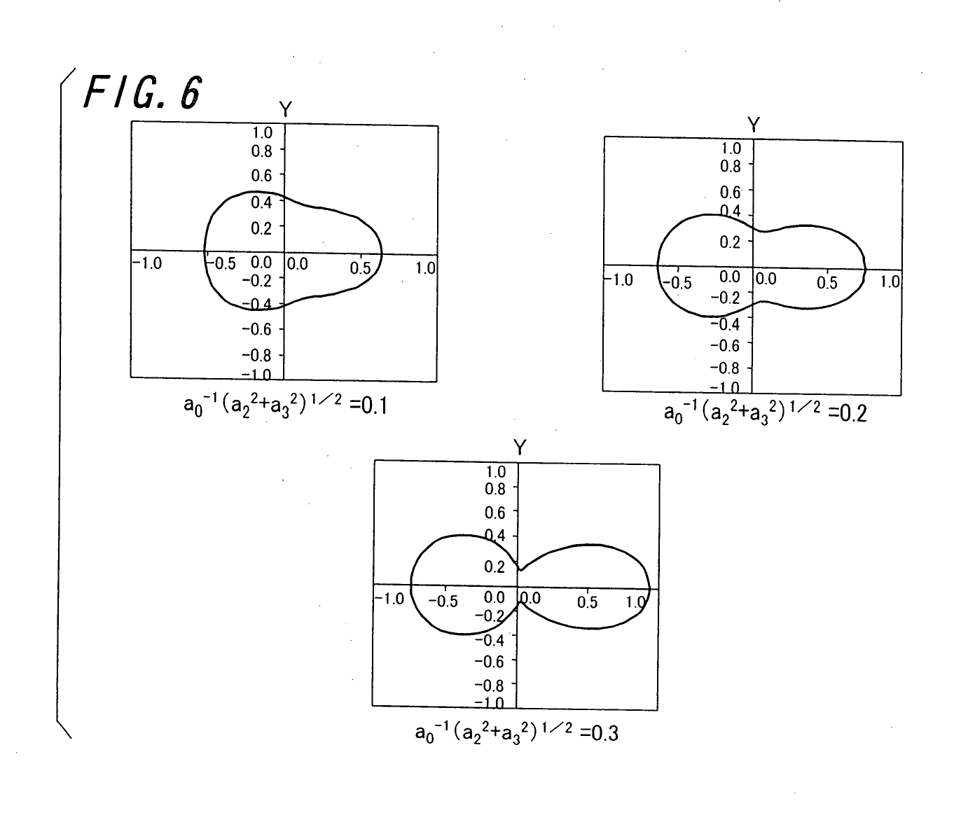

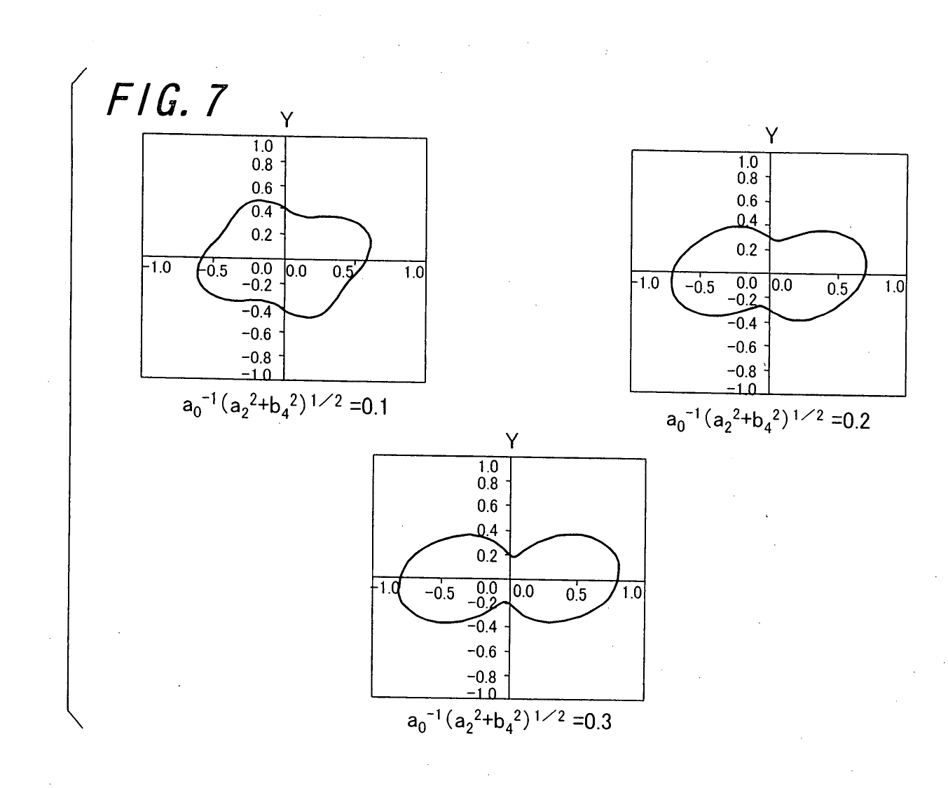

FIG. 5 is a schematic view showing an outline of projection image of heart-shaped toner particle having one bending point. FIG. 6 is a schematic view showing an outline of projection image of calabash-shaped toner particle having two bending points. FIG. 7 is a schematic view showing an outline of projection image of peanut-shaped toner particle having two bending points.

As shown in FIG. 5, an outline form of toner particle changes as the value a₀⁻¹(a₂²+b₃²)^{1/2} of Fourier coefficient changes. It appears that when 0.10≦a₀⁻¹(a₂²+b₃²)^{1/2}≦0.38 is satisfied, one of the two bending points of fine particles joined in the aggregating process is flattened, thereby forming a toner particle having one bending point remaining at center thereof. The toner having a particle shaped as above can be easily caught by the cleaning blade as well as coming into point-contact with the to-be-transferred member, therefore allowing for combination of cleaning property and transferring property. By defining a relation of the coefficients as a₀⁻¹(a₂²+b₃²)^{1/2}, the form can be defined even when not the distance from an intersection of a major axis with a minor axis to the outline but the distance from the center of gravity to the outline is plotted.

As shown in FIG. 6, an outline form of toner particle changes as the value a₀⁻¹(a₂²+a₃²)^{1/2} of Fourier coefficient changes. It appears that when 0.10≦a₀⁻¹(a₂²+a₃²)^{1/2}≦0.38 is satisfied, fine particles different in size come into contact with each other and are thus joined in the aggregating process, thereby forming a calabash-shaped toner particle. The toner thus has a particle with its outline including two bending points as in the case of the cocoon-shaped toner, and can be therefore easily caught by the cleaning blade as well as coming into point-contact with the to-be-transferred member, which allows for combination of cleaning property and transferring property.

As shown in FIG. 7, an outline form of toner particle changes as the value a₀⁻¹(a₂²+b₄²)^{1/2} of Fourier coefficient changes. It appears that when 0.09≦a₀⁻¹(a₂^{2+b}₄²)^{1/2}≦0.38 is satisfied, fine particles asymmetrically come into contact with each other and are thus joined in the aggregating process, thereby forming a peanut-shaped toner particle. The toner thus has a particle with its outline including two bending points as in the case of the cocoon-shaped toner, and can be therefore easily caught by the cleaning blade as well as coming into point-contact with the to-be-transferred member, which allows for combination of cleaning property and transferring property.

As above, all the toner particles shown in FIG. 5 to FIG. 7 with the Fourier coefficients equal to or less than the prescribed values have so small dents that no effect of enhanced cleaning property can be exerted, as in the cases of the cocoon-shaped toner and the tetrapod-shaped toner. On the other hand, toners with the Fourier coefficients larger than the prescribed values will have so large dents that the collapse probability due to external force becomes higher, resulting in a failure to exert effects of a transferring property and charge uniformity.

It is preferable that coefficients a₀, a₂, and b₁ in the expression (1) satisfy 0.05≦a₂/a₀≦0.15 and 0.25≦(a₂/a₀+b₁/a₀)≦0.50 in a Fourier series expansion of a waveform of plots of distance f(x)(μm) from a center of gravity of the defined outline to the outline at a given angle x (rad) where a distance from an intersection of a major axis with a minor axis of the outline to the outline is the longest at zero angle (rad).

The toner having a particle with its outline including one bending point and its fractions of Fourier coefficient satisfying 0.05≦a₂/a₀≦0.15 and 0.25≦(a₂/a₀+b₁/a₀)≦0.50 can be easily caught by a cleaning blade as well as coming into point-contact with a to-be-transferred member, therefore being capable of having both of cleaning property and transferring property. Further, the toner particles have a uniform curvature and therefore have surfaces uniformly charged. The form of the toner particle with the fraction a₂/a₀ of Fourier coefficient less than 0.05 (0.25≦(a₂/a₀+b₁/a₀)≦0.50) is close to a perfect sphere, therefore failing to exert an effect of enhanced cleaning property. Further, the toner particle with the fraction a₂/a₀ of Fourier coefficient of 0.15 or more (0.25≦(a₂/a₀+b₁/a₀)≦0.50) has a large linear area and curvature thereof is therefore not constant, causing a failure to exert effects of a transferring property and equalizing a charge amount of toner surface. When the Fourier coefficient a₂/a₀+b₁/a₀ is less than 0.25 (0.05≦a₂/a₀≦0.15), a dent is too small to exert an effect of enhanced cleaning property. The Fourier coefficient a₂/a₀+b₁/a₀ of 0.5 or more (0.05≦a₂/a₀≦0.15) indicates a particle form capable of enclosing an ellipse therein, and is a mathematical limit for showing the outline.

The Fourier coefficient of toner particles can be determined as follows.

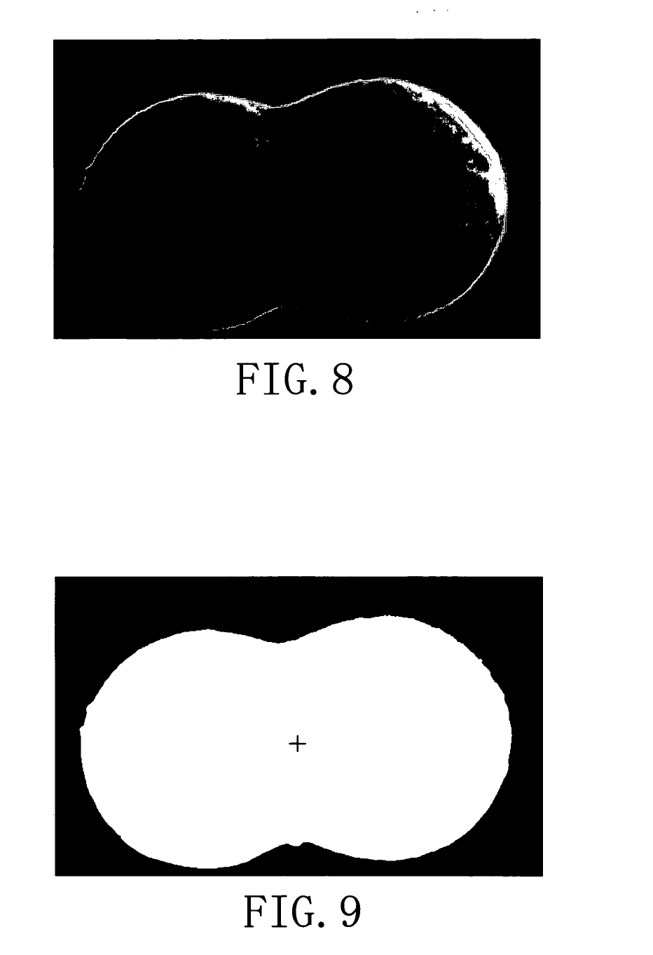

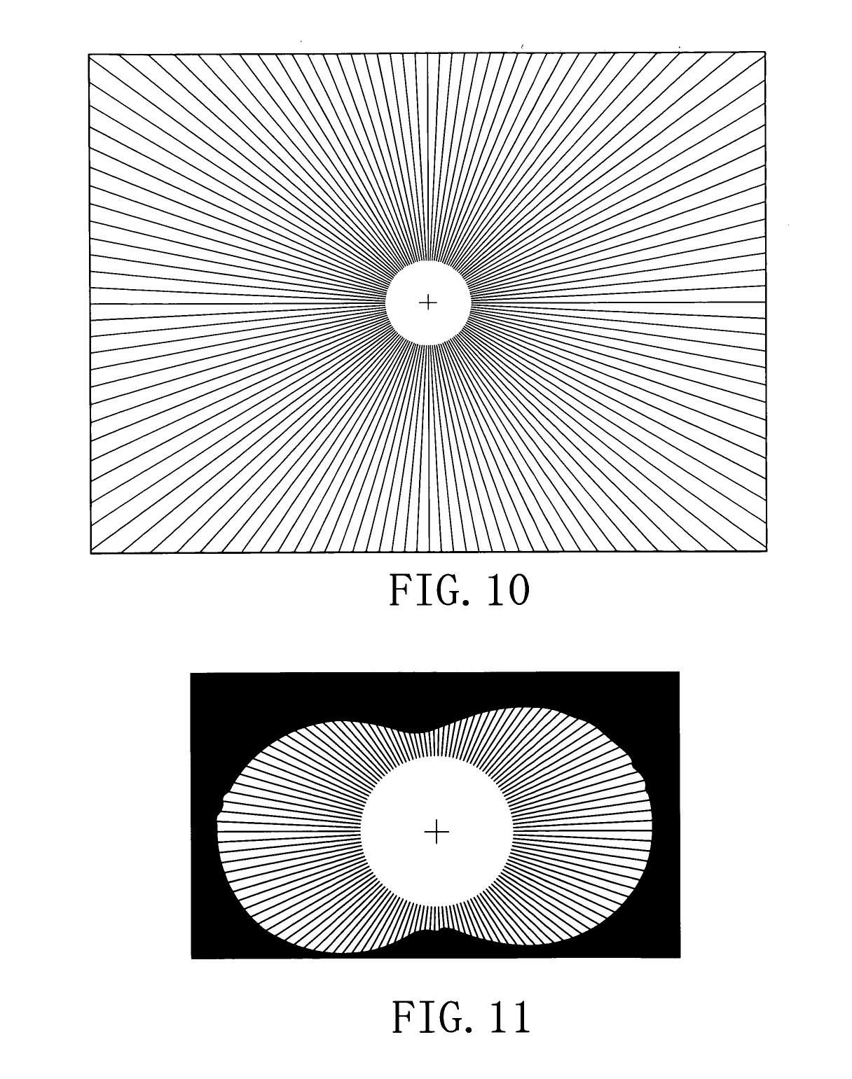

FIG. 8 is a view showing an SEM photograph image of cocoon-shape toner particle having two bending points. FIG. 9 is a projection view obtained by defining an outline of the photograph image of FIG. 8. FIG. 10 is a 360-degree radiation view equally divided from its center into 128 parts. FIG. 11 is a view obtained by overlapping a coordinate of the center of gravity of the outline of the projection view of FIG. 9 with the center of the radiation view of FIG. 10.

Firstly, as shown in FIG. 8, a toner particle is photographed, for example, by an electronic microscope such as SEM. Using image analysis software, etc., a photograph image of toner particle obtained as above is formed into a projection view by defining the outline on the image and then analyzed, thus determining a coordinate which indicates a center of gravity of the outline. Subsequently, with a center of the 360-degree radiation view equally divided from its center into 128 parts as shown in FIG. 10, a coordinate of the center of gravity of outline of the projection view is overlapped as shown in FIG. 11. A length from the center of gravity of the outline to the outline for each of 128 radiate lines is measured by using the image software. Of these 128 radiate lines thus measured, the radiate line having the largest length from the center of gravity to the outline is defined as a starting point (zero degree), and lengths for respective angles are sequentially plotted. A waveform thus plotted is then subject to Fourier analysis by using a commercially available tool or the like device to determine cosine Fourier coefficients a₁ to a₆₄ from a real part of the following expression (2) and determine sine Fourier coefficients b₁ to b₆₄ from an imaginary part of the following expression (2).

f(x)=a₀/2+Σ(aₙ cos [nx]+bₙ sin [nx])(n:1 to 64) (2)

In the above expression, a₀ corresponds to a volume average particle size, and a₀ is in proportion to both of aₙ and bₙ. A Fourier coefficient indicative of particle form is thus represented by a ratio to a₀, i.e. an/a₀ and bₙ/a₀. Fourier coefficients a₂, a₃, b₂, b₃, and b₄ of 100 toner particles selected at random are determined.

The volume average particle size of the obtained toner particles is preferably 3 μm or more and 10 μm or less. Using such a toner, high definition and high resolution images can be formed. The toner particles having a volume average particle size less than 3 μm are too small in size and may be highly charged or decreased in fluidity. The toner having such particles which are highly charged or decreased in fluidity as above, cannot be stably supplied to a photoreceptor, possibly causing background fog and a decrease in image density. On the other hand, the toner particles having a volume average particle size exceeding 10 μm are too large to obtain high resolution images. As just described, the toner having particles larger in size has decreased specific surface area and is less charged. The toner less charged cannot be stably supplied to the photoreceptor and may scatter inside the apparatus, thus causing contamination thereof.

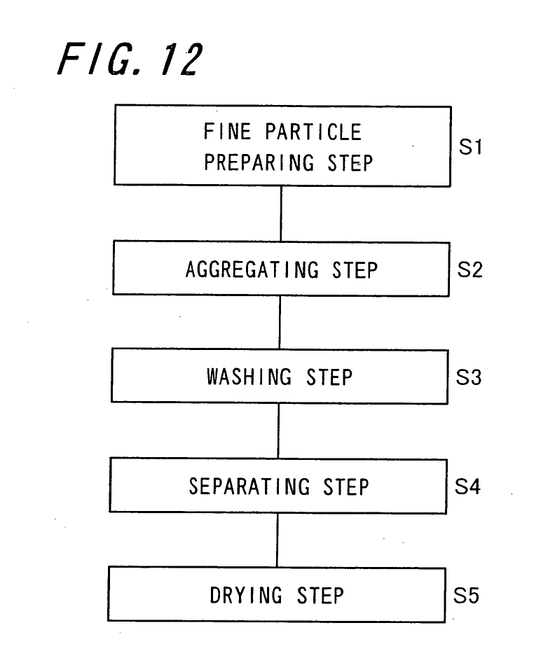

FIG. 12 is a flowchart showing a procedure of a method of manufacturing the toner according to an embodiment of the invention. The method of manufacturing the toner according to the embodiment of the invention includes a fine particle preparing step S1, an aggregating step S2, a washing step S3, a separating step S4, and a drying step S5.

[Fine Particle Preparing Step]

In the fine particle preparing step S1, dispersion (A) is prepared in which at least fine resin particles and fine colorant particles are dispersed in an aqueous medium, or alternatively dispersion (B) is prepared in which fine coloring resin particles containing at least binder resin and colorant are dispersed in an aqueous medium.

The aqueous medium is not particularly limited, and in view of ease of controls over the steps, the waste liquid disposal after completion of all the steps, and ease in handling, water is preferably selected as the aqueous medium. Usable examples of water include ion-exchange water, distilled water, and pure water.

A method of preparing the dispersion (A) in which the fine resin particles and the fine colorant particles are dispersed in the aqueous medium, is different from a method of preparing the dispersion (B) in which the fine coloring resin particles containing the binder resin and the colorant are dispersed in the aqueous medium. Hence, there will be firstly given an explanation of the method of preparing the dispersion (A) in which the fine resin particles and the fine colorant particles are dispersed in the aqueous medium.

The dispersion (A) in which the fine resin particles and the fine colorant particles are dispersed in the aqueous medium, is obtained by mixing fine resin particle dispersion (A1) in which the fine resin particles are dispersed in the aqueous medium, with dispersion (A2) in which the fine colorant particles are dispersed in the aqueous medium.

The binder resin in the fine resin particle dispersion (A1) is not particularly limited. Usable examples of the binder resin include a thermoplastic polymer of monomers of: styrenes such as styrene, parachlorostyrene, and α-methylstyrene; esters having a vinyl group such as methyl acrylate, ethyl acrylate, n-propyl acrylate, lauryl acrylate, 2-ethylhexyl acrylate, methyl methacrylate, ethyl methacrylate, n-propyl methacrylate, lauryl methacrylate, 2-ethylhexyl methacrylate; vinyl nitrites such as acrylonitrile and methacrylonitrile; vinylethers such as vinyl methyl ether and vinyl isobutyl ether; vinyl ketones such as vinyl methyl ketone, vinyl ethyl ketone, and vinyl isopropenyl ketone; and polyolefins such as ethylene, propylene, and butadiene, copolymers of combination of two or more substances among the above monomers, or admixture of two or more substances among the above monomers. Furthermore, the binder resin may be epoxy resin, polyester resin, polyurethane resin, polyamide resin, cellulose resin, polyether resin, non-vinyl condensation resin, admixture of the resin just listed and the vinyl resin listed above, or a grafted polymer obtained by polymerizing vinyl monomers in the presence of the above substances. The binder resin may be used each alone, or two or more of the binder resin may be used in combination.

Using the binder resin monomers, water dispersion containing fine resin particles can be prepared by emulsification polymerization or seed polymerization with the aid of surfactant. In the case of using the other resin, the resin is dissolved in an oily solvent relatively less soluble in water and then put in water to be finely dispersed therein together with the surfactant and polyelectrolyte by using a dispersing device such as a homogenizer, thereafter being heated or depressurized to evaporate the solvent. The fine resin particle dispersion (A1) can be thus prepared.

The binder resin is selected in view of its glass transition temperature (Tg) which is not particularly limited and may be appropriately selected from a wide range. However, in view of preservation stability and a fixing property of the toner to be obtained, the glass transition temperature (Tg) is preferably 50° C. or more and 80° C. or less. The binder resin having a glass transition temperature (Tg) less than 50° C. may increasingly cause blocking that indicates thermal aggregation of toner inside an image forming apparatus, thus leading to a decrease in the preservation stability. The binder resin having a glass transition temperature (Tg) exceeding 80° C. may decrease a fixing property of the toner to a recording medium, thus causing a fixing failure. A softening temperature (Tm) of the binder resin is not particularly limited either and may also be appropriately selected from a wide range, being preferably 150° C. or less and more preferably 60° C. or more and 120° C. or less. The binder resin having a softening temperature (Tm) less than 60° C. may decrease the preservation stability of the toner and increasingly cause the thermal aggregation of toner inside the image forming apparatus, causing a failure to stably supply the toner to an image bearing member and thus causing a developing failure. Further, malfunction of the image forming apparatus may be induced. Furthermore, the toner becomes less easily molten or softened when being fixed to a recording medium and therefore, a fixing property of the toner to the recording medium may decrease and thus cause a fixing failure. A weight average molecular weight of the binder resin is not particularly limited and preferably 5,000 to 500,000.

For the purpose of decreasing a molecular weight of the fine resin particles, a molecular weight modifier can be used. Usable examples of the molecular weight modifier include mercaptans such as t-dodecylmercaptan, n-dodecylmercaptan, and n-oxylmercaptan; and halogenated hydrocarbons such as carbon tetrachloride and carbon tetrabromide. These molecular weight modifiers can be added before the polymerization starts or during the polymerization. A usage of the molecular weight modifier is generally 0.01 to 10 parts by weight and preferably 0.1 to 5 parts by weight based on 100 parts by weight of the binder resin monomer.

For the purpose of increasing the molecular weight of the fine resin particles, a crosslinkable monomer can be used. Usable examples of the crosslinkable monomer include multifunctional monomers such as divinylbenzene, ethylene glycol di(meth)acrylate, glycidyl(meth)acrylate, and trimethylolpropane tri(meth)acrylate. These crosslinkable monomers can be added before the polymerization starts or during the polymerization. A usage of the crosslinkable monomer is generally 0.01 part by weight to 10 parts by weight and preferably 0.5 part by weight to 5 parts by weight based on 100 parts by weight of the binder resin monomer.

An average particle size of the fine resin particles is generally 1 μm or less and preferably 0.01 μm to 1 μm. The fine resin particles having an average particle size exceeding 1 μm result in final toner particles exhibiting a wider particle size distribution or generate free particles, easily causing decreases in toner performance and reliability.

For the aqueous medium used to prepare the fine resin particle dispersion (A1), an aqueous medium containing an inorganic or organic dispersant can be used. It is thus preferable to add a dispersant. The dispersant is preferably added to the aqueous medium before the aqueous medium is added to a toner composition such as the binder resin monomer.

The fine colorant particle dispersion (A2) is obtained by dispersing colorant in the aqueous medium. The fine colorant particles used for preparing the fine colorant particles are not particularly limited and for example, organic dye, organic pigment, inorganic dye, or inorganic pigment may be used for the fine colorant particles.

A usage of the colorant is preferably 5 parts by weight or more and 50 parts by weight or less and more preferably 20 parts by weight or more and 40 parts by weight or less based on 100 parts by weight of the aqueous medium. When the usage of the colorant is less than 5 parts by weight, the amount of the colorant is too small relative to that of the aqueous medium, therefore leading to a decrease in dispersion uniformity. When the usage of the colorant exceeds 50 parts by weight, the amount of the colorant is too large relative to that of the aqueous medium and therefore, the aqueous medium will have excessively high viscosity, also leading to a decrease in the dispersibility.

An average particle size of the colorant is generally 1 μm or less and preferably 0.01 μm to 1 μm. When the colorant having an average particle size exceeding 1 μm is used, final toner particles may exhibit a wider particle size distribution or generate free particles, possibly causing easily decreases in the toner performance and reliability.

Black colorant includes, for example, carbon black, copper oxide, manganese dioxide, aniline black, activated carbon, nonmagnetic ferrite, magnetic ferrite, and magnetite.

Yellow colorant includes, for example, chrome yellow, zinc chrome, cadmium yellow, yellow iron oxide, mineral fast yellow, nickel titanium yellow, navel yellow, naphthol yellow S, hanza yellow G, hanza yellow 10G, benzidine yellow G, benzidine yellow GR, quinoline yellow lake, permanent yellow NCG, tartrazine lake, C.I. pigment yellow 12, C.I. pigment yellow 13, C.I. pigment yellow 14, C.I. pigment yellow 15, C.I. pigment yellow 17, C.I. pigment yellow 74, C.I. pigment yellow 93, C.I. pigment yellow 94, C.I. pigment yellow 138, C.I. pigment yellow 180, and C.I. pigment yellow 185.

Orange colorant includes, for example, red chrome yellow, molybdenum orange, permanent orange GTR, pyrazolone orange, vulcan orange, indanthrene, indanthrene brilliant orange RK, benzidine orange G, indanthrene brilliant orange GK, C.I. pigment orange 31, and C.I. pigment orange 43.

Red colorant includes, for example, red iron oxide, cadmium red, red lead, mercuric sulfide, cadmium, permanent red 4R, lithol red, pyrazolone red, watching red, calcium salt, lake red C, lake red D, brilliant carmine 6B, eosin lake, rhodamine lake B, alizarin lake, brilliant carmine 3B, C.I. pigment red 2, C.I. pigment red 3, C.I. pigment red 5, C.I. pigment red 6, C.I. pigment red 7, C.I. pigment red 15, C.I. pigment red 16, C.I. pigment red 48:1, C.I. pigment red 53:1, C.I. pigment red 57:1, C.I. pigment red 122, C.I. pigment red 123, C.I. pigment red 139, C.I. pigment red 144, C.I. pigment red 149, C.I. pigment red 166, C.I. pigment red 177, C.I. pigment red 178, and C.I. pigment red 222.

Purple colorant includes, for example, manganese violet, fast violet B, and methyl violet lake.

Blue colorant includes, for example, iron blue, cobalt blue, alkali blue lake, Victoria blue lake, phthalocyanine blue, metal-free phthalocyanine, partially chlorinated phthalocyanine blue, fast sky blue, indanthrene blue BC, C.I. pigment blue 15, C.I. pigment blue 15:2, C.I. pigment blue 15:3, C.I. pigment blue 16, and C.I. pigment blue 60.

Green colorant includes, for example, chrome green, chrome oxide, pigment green B, malachite green lake, final yellow green G, and C.I. pigment green 7.

White colorant includes, for example, compounds of zinc oxide, titanium oxide, antimony white, zinc sulfide, and the like substance.

The colorant may be used each alone, or two or more of the colorants of different colors may be used in combination. And two or more of the colorants of the same color may also be used in combination.

For the aqueous medium used to prepare the fine colorant particle dispersion (A2), an aqueous medium containing an inorganic or organic dispersant can be used. It is thus preferable to add a dispersant. The dispersant is preferably added to the aqueous medium before the aqueous medium is added to a toner composition such as the colorant.

For the inorganic dispersant, a hydrophilic inorganic dispersant is preferred. When the hydrophilic inorganic dispersant is used, fine particles of the colorant in a liquid medium can be more uniform. Examples of the hydrophilic inorganic dispersant include silica, alumina, titania, calcium carbonate, magnesium carbonate, tricalcium phosphate, clay, diatom earth, and bentoite, among which calcium carbonate is preferred.

A number average particle size of primary particles of the above inorganic dispersant is preferably 1 nm or more and 1,000 nm or less, more preferably 5 nm or more and 500 nm or less, and yet more preferably 10 nm or more and 300 nm or less. The inorganic dispersant whose primary particles having a number average particle size less than 1 nm is hard to be dispersed in the aqueous medium. When the number average particle size of primary particles of the inorganic dispersant exceeds 1,000 nm, there is a smaller difference between the particle size of coarse particles of the colorant and the particle size of the inorganic dispersant, therefore making it difficult for the coarse particles of the colorant to be stably dispersed and maintained in the liquid.

A usage of the inorganic dispersant is preferably 1 part by weight or more and 300 parts by weight or less and more preferably 4 parts by weight or more and 100 parts by weight or less based on 100 parts by weight of the colorant. When the usage of the inorganic dispersant is less than 1 part by weight, it is difficult to disperse the inorganic dispersant in the aqueous medium. When the usage of the inorganic dispersant exceeds 300 parts by weight, the liquid medium may have excessively high viscosity and cause a decrease in the dispersibility.

Further, to the aqueous medium, a polymer dispersant may be added together with the inorganic dispersant. For examples of the polymer dispersant, a hydrophilic dispersant is preferable, a carboxylic dispersant is more preferable, and a dispersant free from oleophilic groups such as hydroxypropoxy group and methoxyl group is particularly preferable. Such polymer dispersants include, for example, water-soluble cellulose ethers such as carboxymethylcellulose and carboxyethylcellulose, among which carboxymethylcellulose is particularly preferable. A usage of the polymer dispersant is preferably 0.1 part by weight or more and 5.0 parts by weight or less based on 100 parts by weight of the colorant.

For the organic dispersant, an anionic dispersant is preferred. The anionic dispersant has an excellent ability of enhancing the dispersibility of the colorant particles into water. Examples of the anionic dispersant include a sulfonate anionic dispersant, a sulfate anionic dispersant, a polyoxyethylene ether anionic dispersant, a phosphate anionic dispersant, and polyacrylate. As specific examples of the anionic dispersant, sodium dodecylbenzene sulfonate, sodium polyacrylate, or polyoxyethylene phenylether can be preferably used. The anionic dispersant may be used each alone, or two or more of the anionic dispersants may be used in combination.

The organic dispersant is not limited to the anionic dispersant and may be a cationic dispersant. Preferable examples of the cationic dispersant include an alkyltrimethyl ammonium cationic dispersant, an alkylamide amine cationic dispersant, an alkyldimethylbenzyl ammonium cationic dispersant, a cationized polysaccharide cationic dispersant, an alkylbetaine cationic dispersant, an alkylamide betaine cationic dispersant, a sulfobetaine cationic dispersant, an amineoxide cationic dispersant and metal salt. Examples of the metal salt include chlorides and sulfates of sodium, potassium, calcium, magnesium, etc.

Among the cationic dispersants listed above, the alkyltrimethyl ammonium cationic dispersant is more preferable. Specific examples of the alkyltrimethyl ammonium cationic dispersant include stearyltrimethyl ammonium chloride, tri(polyoxyethylene) stearylammonium chloride, and lauryl trimethyl ammonium chloride. The cationic dispersant may be used each alone, or two or more of the cationic dispersant may be used in combination.

An amount of the organic dispersant to be added is not particularly limited and may be appropriately selected from a wide range, being preferably 0.1 part by weight or more and 5 parts by weight or less based on 100 parts by weight of the colorant. The amount of the organic dispersant less than 0.1 part by weight is not enough to sufficiently exert its effect of dispersing the colorant, possibly causing aggregation. The amount of the organic dispersant more than 5 parts by weight brings only the effect of dispersing the colorant not higher than its effect obtained when 5 parts by weight of the organic dispersant is added. Rather, in the case where more than 5 parts by weight of the organic dispersant is added, the colorant slurry will have higher viscosity which decreases the dispersibility of the colorant, possibly resulting in the aggregation.

For the dispersant, a commercially available dispersant can be used. Examples of the commercially available dispersant include: BYK-182, BYK-161, BYK-116, BYK-111, and BYK-2000 (all of which are manufactured by BYK Japan KK.); Solsperse-2000 and Solsperse-38500 (both of which are manufactured by Avecia KK); EFKA-4046 and EFKA-4047 (both of which are manufactured by EFKA Chemicals B.V.); and SURFYNOL GA (manufactured by Air Products Inc.). These commercially available dispersants may be used each alone, or two or more of the dispersants may be used in mixture.

A usage of such a commercially available dispersant is preferably 10 parts by weight or more and 100 parts by weight or less and more preferably 20 parts by weight or more and 50 parts by weight or less based on 100 parts by weight of the colorant. When the usage of the commercially available dispersant is less than 10 parts by weight, the dispersant will exert an insufficient effect of dispersing the colorant, possibly causing the aggregation. When the usage of the commercially available dispersant exceeds 100 parts by weight, the colorant slurry will have higher viscosity which decreases the dispersibility of the colorant, possibly resulting in the aggregation.

The aqueous medium and the dispersant can be mixed in a known method which is not particularly limited. In the case of mixing the inorganic dispersant and the aqueous medium, the inorganic dispersant can be dispersed in the aqueous medium by using a media-containing dispersing device such as a ball mill or a sand mill, a high-pressure dispersing device, an ultrasonic dispersing device, or the like device. In the case of mixing the organic dispersant and the aqueous medium, the addition and the dispersion may be carried out in any method which enables the dispersant to be evenly dissolved in water. The liquid medium and colorant obtained by mixing the aqueous medium and the dispersant are treated with a high-pressure homogenizer, for example. By so doing, the colorant is formed into fine particles. It is thus possible to obtain colorant slurry, that is, the colorant fine particle dispersion (A2) having the colorant dispersed in the liquid medium.

In the dispersion (A) in which at least the fine resin particles and the fine colorant particles are dispersed in the aqueous medium, fine release agent-particle dispersion having a release agent dispersed in an aqueous medium may also be put for the purpose of improving a fixing property of the toner.

The release agent is not particularly limited including, for example, petroleum wax such as polyester wax and derivatives thereof, paraffin wax and derivatives thereof, and microcrystalline wax and derivatives thereof; hydrocarbon-based synthetic wax such as Fischer-Tropsch wax and derivatives thereof, polyolefin wax and derivatives thereof, low-molecular-weight polypropylene wax and derivatives thereof, and polyolefinic polymer wax (low-molecular-weight polyethylene wax, etc.) and derivatives thereof; vegetable wax such as carnauba wax and derivatives thereof, rice wax and derivatives thereof, candelilla wax and derivatives thereof, and haze wax; animal wax such as bees wax and spermaceti wax; fat and oil-based synthetic wax such as fatty acid amides and phenolic fatty acid esters; long-chain carboxylic acids and derivatives thereof; long-chain alcohols and derivatives thereof; silicone polymers; and higher fatty acids. Examples of the derivatives include oxides, block copolymers of a vinylic monomer and the above wax, and graft-modified derivatives of a vinylic monomer and the above wax.

A melting temperature of the release agent is preferably 60° C. or more and 130° C. or less. The use of the release agent having a melting temperature less than 60° C. may cause toner particle-to-particle aggregating inside the image forming apparatus which leads to a decrease in the preservation stability. The release agent having a melting temperature exceeding 130° C. may not be sufficiently molten when the toner is heated to be fixed, possibly causing high-temperature offset. Accordingly, by using the release agent whose melting temperature falls within the preferable range stated above, it is possible to obtain a toner which is excellent in the preservation stability as well as capable of preventing the high-temperature offset. A content of the release agent is not particularly limited and may be appropriately selected from a wide range, being preferably 0.2% by weight to 20% by weight based on a total amount of the toner composition.

In the dispersion (A) in which at least the fine resin particles and the fine colorant particles are dispersed in the aqueous medium, dispersion having other additives dispersed in an aqueous medium may also be put for the purpose of improving the properties of the toner.

Next, the method of preparing the dispersion (B) will be explained in which the fine coloring resin particles containing binder resin and colorant are dispersed in an aqueous medium. The fine coloring resin particles are obtained by dispersing in an aqueous medium at least binder resin and molten and kneaded materials having a molten and kneaded toner composition of colorant.

The binder resin for use in preparing the fine coloring resin particles is not particularly limited and may be resin customarily used as binder resin for toner, including polyester resin, polyurethane resin, epoxy resin, acrylic resin, and styrene-acrylic resin among which polyester resin, acrylic resin, and styrene-acrylic resin are preferred. The resin may be used each alone, or two or more of the resin may be used in combination. Further, a plurality of resin of the same kind different in any one or plural elements of their molecular weight, monomer composition, etc. may be used in combination.

Polyester resin is preferable as binder resin for toner owing to its excellent transparency, low-temperature fixing property, and secondary color reproducibility. For polyester resin, known substances can be used including a polycondensation of polybasic acid and polyvalent alcohol. For polybasic acid, substances known as monomers for polyester can be used including, for example: aromatic carboxylic acids such as terephthalic acid, isophthalic acid, phthalic anhydride, trimellitic anhydride, pyromellitic acid, and naphthalene dicarboxylic acid; aliphatic carboxylic acids such as maleic anhydride, fumaric acid, succinic acid, alkenyl succinic anhydride, and adipic acid; and methyl-esterified compounds of these polybasic acids. The polybasic acids may be used each alone, or two or more of the polybasic acids may be used in combination. For polyvalent alcohol, substances known as monomers for polyester can also be used including, for example: aliphatic polyvalent alcohols such as ethylene glycol, propylene glycol, butanediol, hexanediol, neopentyl glycol, and glycerin; alicyclic polyvalent alcohols such as cyclohexanediol, cyclohexanedimethanol, and hydrogenated bisphenol A; and aromatic diols such as ethylene oxide adduct of bisphenol A and propylene oxide adduct of bisphenol A. The polyvalent alcohols may be used each alone, or two or more of the polyvalent alcohols may be used in combination. The polybasic acid and the polyvalent alcohol can undergo polycondensation reaction in an ordinary manner, that is, for example, the polybasic acid and the polyvalent alcohol are brought into contact with each other in the presence or absence of the organic solvent and in the presence of the polycondensation catalyst. The polycondensation reaction ends when an acid number, a softening temperature, etc. of the polyester resin to be produced become predetermined values. The polyester resin is thus obtained. When the methyl-esterified compound of the polybasic acid is used as part of the polybasic acid, dimethanol polycondensation reaction is caused. In the polycondensation reaction, a compounding ratio, a reaction rate, etc. of the polybasic acid and the polyvalent alcohol are appropriately modified, thereby being capable of adjusting a content of a carboxyl end group in the polyester resin and thus allowing for denaturation of the polyester resin. The denatured polyester can be obtained also by introducing a carboxyl group to a main chain of the polyester with use of a carboxylic group as polybasic acid. Note that polyester self-dispersible in water may also be used which polyester resin has a main chain or side chain bonded to a hydrophilic radical such as a carboxyl group or a sulfonate group. Further, the polyester resin may be grafted with acrylic resin.

The acrylic resin is not particularly limited, and acid group-containing acrylic resin can be preferably used. The acid group-containing acrylic resin can be produced, for example, by polymerization of acidic group- or hydrophilic group-containing acrylic resin monomers or polymerization of the acrylic resin monomer and an acidic group- or hydrophilic group-containing vinylic monomer. The acrylic resin monomer is not particularly limited, and may be a known substance including, for example, acrylic acid, methacrylic acid, acrylic acid ester, and methacrylic acid ester. The acrylic resin monomer may have a substituent group. Specific examples of the above acrylic resin monomers include: monomers of acrylic esters such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, n-octyl acrylate, decyl acrylate, and dodecyl acrylate; monomers of methacrylic esters such as methyl methacrylate, propyl methacrylate, n-butyl methacrylate, isobutyl methacrylate, n-amyl methacrylate, n-hexyl methacrylate, 2-ethylhexyl methacrylate, n-octyl methacrylate, decyl methacrylate, and dodecyl methacrylate; hydroxyl group-containing monomers of acrylic esters such as hydroxyethyl acrylate; and hydroxyl group-containing monomers of methacrylic esters such as hydroxypropyl methacrylate. The acrylic resin monomers may be used each alone, or two or more of the acrylic resin monomers may be used in combination. The vinylic resin monomer is not particularly limited, and may be a known substance including, for example, styrene, α-methylstyrene, vinyl bromide, vinyl chloride, vinyl acetate, acrylonitrile, and methacrylonitrile. The vinylic monomers may be used each alone, or two or more of the vinylic monomers may be used in combination. The polymerization is effected by use of a commonly-used radical initiator in accordance with a solution polymerization method, a suspension polymerization method, an emulsification polymerization method, or the like method.

The styrene-acryl resin is not particularly limited and includes, for example, a styrene-acrylic acid methyl copolymer, a styrene-acrylic acid ethyl copolymer, a styrene-acrylic acid butyl copolymer, a styrene-methacrylic acid methyl copolymer, a styrene-methacrylic acid ethyl copolymer, a styrene-methacrylic acid butyl copolymer, and a styrene-acrylonitrile copolymer.

A glass transition temperature (Tg) of the binder resin is not particularly limited and may be appropriately selected from a wide range. In view of preservation stability and a fixing property of the toner to be obtained, the glass transition temperature (Tg) is preferably 50° C. or more and 80° C. or less. The binder resin having a glass transition temperature (Tg) less than 50° C. may increasingly cause blocking that indicates thermal aggregating of the toner inside an image forming apparatus, thus leading to a decrease in the preservation stability. The binder resin having a glass transition temperature (Tg) exceeding 80° C. may decrease a fixing property of the toner to a recording medium, thus causing a fixing failure. A softening temperature (Tm) of the binder resin is not particularly limited either and may also be appropriately selected from a wide range, being preferably 150° C. or less and more preferably 60° C. or more and 120° C. or less. The binder resin having a softening temperature (Tm) less than 60° C. may decrease the preservation stability of the toner and increasingly cause the thermal aggregating of the toner inside the image forming apparatus, causing a failure to stably supply the toner to an image bearing member and thus causing a developing failure. Further, malfunction of the image forming apparatus may be induced. The binder resin having a softening temperature (Tm) exceeding 120° C. is less easily softened and therefore becomes hard to be molten and kneaded during the melting and kneading process in the fine particle preparing step, possibly leading to a decrease in the dispersibility of the colorant, release agent, and charge control agent in the binder resin. Furthermore, the toner becomes less easily molten or softened when being fixed to a recording medium and therefore, a fixing property of the toner to the recording medium may decrease and thus cause a fixing failure. A weight average molecular weight of the binder resin is not particularly limited and preferably 5,000 to 500,000.

The colorant is not particularly limited and may be the same one used for preparing the fine colorant particle dispersion (A2).

The release agent is not particularly limited and may be the same one used for preparing the fine colorant particle dispersion (A2).

The charge control agent is not particularly limited and includes a positive charge control agent and a negative charge control agent. The positive charge control agent includes, for example, basic dye, quaternary ammonium salt, quaternary phosphonium salt, aminopyrane, a pyrimidine compound, a polynuclear polyamino compound, aminosilane, a nigrosine dye, a derivative thereof, a triphenylmethane derivative, guanidine salt, and amidine salt. The negative charge control agent includes oil-soluble dyes such as oil black and spiron black, a metal-containing azo compound, an azo complex dye, metal salt naphthenate, salicylic acid, metal complex and metal salt (the metal includes chrome, zinc, and zirconium) of a salicylic acid derivative, a fatty acid soap, long-chain alkylcarboxylic acid salt, and a resin acid soap. The above charge control agents may be used each alone and according to need, two or more of the above agents may be used in combination. A usage of the charge control agent is not limited to a particular level and may be selected as appropriate from a wide range, preferably being 0.5% by weight to 3% by weight based on the total amount of the toner composition.

The toner composition containing the binder resin and colorant stated as above and other toner additive component is dry-mixed by a mixer and thereafter molten and kneaded under heat at a temperature which is equal to the softening temperature and less than the decomposition temperature of the binder resin, for example, in the order of 80° C. or more and 200° C. or less and preferably 100° C. or more and 150° C. or less so that the binder resin is softened to have the colorant and the toner additive component dispersed therein. The toner composition may be directly molten and kneaded without preliminarily mixed. However, the preliminary mixing process is preferably conducted before the melting and kneading process because the preliminary mixing process causes the additive components such as the colorant and the release agent other than the binder resin are more dispersible into the binder resin so that the obtained toner can exhibit more uniform properties including chargeability.

For the mixer, a known mixer can be used including, for example, a Henschel-type mixing device such as HENSCHELMIXER (trade name) manufactured by Mitsui Mining Co., Ltd., SUPERMIXER (trade name) manufactured by Kawata MFG Co., Ltd., MECHANOMILL (trade name) manufactured by Okada Seiko Co., Ltd., ANGMILL (trade name) manufactured by Hosokawa Micron Corporation, HYBRIDIZATION SYSTEM (trade name) manufactured by Nara Machinery Co., Ltd., and COSMOSYSTEM (trade name) manufactured by Kawasaki Heavy Industries, Ltd.

For the kneader, a known kneader can be used including, for example, a commonly-used kneader such as a twin-screw extruder, a three roll mill, or laboplast mill. Specific examples of such a kneader include single or twin screw extruders such as PCM-30 and PCM-65/87, both of which are trade names and manufactured by Ikegai Ltd., TEM-100B (trade name) manufactured by Toshiba Machine Co., Ltd., and open roll-type kneading machines such as KNEADEX (trade name) manufactured by Mitsui Mining Co., Ltd. Among these kneaders, the open roll-type kneading machines are preferred.

After molten and kneaded, kneaded materials of the toner composition are cooled down to a room temperature and then pulverized into predetermined-sized particles. For the pulverization, a powder pulverizing device is used such as a cutter mill, a feather mill, or a jet mill. Pulverized materials of kneaded toner composition are thus obtained. The pulverized materials obtained by pulverizing the kneaded toner composition will be hereinafter referred to molten and kneaded materials. A volume average particle size of the molten and kneaded materials is not particularly limited and preferably 50 μm to 1,000 μm and more preferably 150 μm to 400 μm.

The molten and kneaded materials obtained as above are mixed with an aqueous medium containing surfactant. The aqueous medium is not particularly limited as long as it is liquid in which the molten and kneaded materials containing the binder resin are not dissolved but evenly dispersed. In view of ease of controls over the steps, the waste liquid disposal after completion of all the steps, and ease in handling, water is preferably selected as the aqueous medium. It is preferred that the water used as the aqueous medium has electric conductivity of 20 μS/cm or less. Such washing water can be prepared, for example, by an activated carbon method, an ion-exchange method, a distillation method, a reverse osmosis method, or the like method. Of these methods, two or more methods may be combined to prepare the water.

The surfactant further enhances the dispersibility of the molten and kneaded materials into the aqueous medium. The surfactant to be selected is dissolved in the aqueous medium and causes the molten and kneaded materials to be not dissolved but evenly dispersed when the surfactant is added thereto. The surfactant is preferably added to the aqueous medium to which the molten and kneaded materials are not yet added. For the surfactant, anionic surfactant is preferred. The anionic surfactant has an excellent ability of enhancing the dispersibility of the fine resin particles into water. Examples of the anionic surfactant include sulfonate anionic surfactant, sulfate anionic surfactant, polyoxyethylene ether anionic surfactant, phosphate anionic surfactant, and polyacrylate. As specific examples of the anionic surfactant, sodium polyacrylate, sodium dodecylbenzene sulfonate, or polyoxyethylene phenylether can be preferably used. The anionic surfactant may be used each alone, or two or more of the anionic surfactants may be used in combination. The surfactant is not limited to the anionic surfactant and may be a cationic dispersant which is used as the later-described aggregating agent.

An amount of the surfactant to be added is not particularly limited and preferably 0.1% by weight to 5% by weight of a total weight of an admixture of the molten and kneaded materials and the aqueous medium containing the surfactant. The amount of the surfactant less than 0.1% by weight is not enough to sufficiently exert its effect of dispersing the fine resin particles into the aqueous medium, possibly causing excessive aggregating. The amount of the surfactant more than 5% by weight brings only the effect of dispersing the fine resin particles not higher than its effect obtained when 5% by weight of the surfactant is added. Rather, in the case where more than 5% by weight of the surfactant is added, the surfactant-containing aqueous medium having the fine resin particles dispersed therein will have higher viscosity which decreases the dispersibility of the fine resin particles, possibly resulting in the excessive aggregating.

To the aqueous medium, dispersion stabilizer, viscosity improver, or the like agent may be added. The dispersion stabilizer can stabilize the dispersion of the molten and kneaded materials into the aqueous medium. The viscosity improver is effective for forming the molten and kneaded materials into finer particles.

For the dispersion stabilizer, those customarily used in this relevant filed can be used among which water-soluble polymer dispersion stabilizer is preferred. The water-soluble polymer dispersion stabilizer includes, for example, acrylic polymer, methacrylic polymer, polyoxyethylene polymer, cellulose polymer, polyoxyalkylene alkylarylether sulfate salt, and polyoxyalkylene alkylether sulfate salt.

The acrylic polymer and the methacrylic polymer each include one or two hydrophilic monomers selected from: acrylic monomers such as acrylic acid, methacrylic acid, α-cyanoacrylate, α-cyanomethacrylate, itaconic acid, crotonic acid, fumaric acid, maleic acid, and maleic acid anhydride; hydroxyl-containing acrylic monomers such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, and 3-chloro-2-hydroxypropyl methacrylate; ester monomers such as diethylene glycol monoacrylic ester; diethylene glycol monomethacrylic ester, glycerine monoacrylic ester, and glycerine monomethacrylic ester; vinyl alcohol monomers such as N-methylol acrylamide and N-methylol methacrylamide; vinylalkylether monomers such as vinylmethylether, vinylethylether, and vinylpropylether; vinylalkylester monomers such as vinyl acetate, vinyl propionate, and vinyl butyrate; aromatic vinyl monomers such as styrene, α-methylstyrene, and vinyl toluene; amide monomers such as acrylamide, methacrylamide, diacetone acrylamide, and methylol compounds thereof; nitrile monomers such as acrylonitrile and methacrylonitrile; acid chloride monomers such as chloride acrylate and chloride methacrylate; vinyl nitrogen-containing heterocyclic monomers such as vinylpyridine, vinylpyrrolidone, vinylimidazole, and ethyleneimine; and cross-linking monomers such as ethyleneglycol dimethacrylate, diethyleneglycol dimethacrylate, allyl methacrylate, and divinylbenzene.

The polyoxyethylene polymer includes polyoxyethylene, polyoxypropylene, polyoxyethylene alkylamine, polyoxypropylene alkylamine, polyoxyethylene alkylamide, polyoxypropylene alkylamide, polyoxyethylene nonylphenylether, polyoxyethylene laurylphenylether, polyoxyethylene stearylphenylester, and polyoxyethylene nonylphenylester.

The cellulose polymer includes methylcellulose, hydroxyethylcellulose, and hydroxypropylcellulose.

The polyoxyalkylene alkylarylether sulfate salt includes sodium polyoxyethylene laurylphenylether sulfate, potassium polyoxyethylene laurylphenylether sulfate, sodium polyoxyethylene nonylphenylether sulfate, sodium polyoxyethylene oleylphenylether sulfate, sodium polyoxyethylene cetylphenylether sulfate, ammonium polyoxyethylene laurylphenylether sulfate, ammonium polyoxyethylene nonylphenylether sulfate, and ammonium polyoxyethylene oleylphenylether sulfate.

The polyoxyalkylene alkylether sulfate salt includes sodium polyoxyethylene laurylether sulfate, potassium polyoxyethylene laurylether sulfate, sodium polyoxyethylene oleylether sulfate, sodium polyoxyethylene cetylether sulfate, ammonium polyoxyethylene laurylether sulfate, and ammonium polyoxyethylene oleylether sulfate. One of the dispersion stabilizers may be used each alone, or two or more of the dispersion stabilizers may be used in combination. An amount of the dispersion stabilizer to be added is not particularly limited, being preferably 0.05% by weight to 10% by weight and more preferably 0.1% by weight to 3% by weight of the total weight of the admixture of the molten and kneaded materials and the aqueous medium containing the surfactant.

For the viscosity improver, preferred is polysaccharide viscosity improver selected from synthetic polymer polysaccharide and natural polymer polysaccharide. For the synthetic polymer polysaccharide, a known substance can be used including, for example, cationized cellulose, hydroxyethylcellulose, starch, an ionized starch derivative, or a block polymer of starch and synthetic polymer. Examples of the natural polymer polysaccharide include hyaluronan, carrageenan, locust bean gum, xanthan gum, guar gum, and gellan gum. One of the viscosity improvers may be used each alone, or two or more of the viscosity improvers may be used in combination. An amount of the viscosity improver to be added is not particularly limited and preferably is 0.01% by weight to 2% by weight of the total weight of the admixture of the molten and kneaded materials and the aqueous medium containing the surfactant.

The molten and kneaded materials containing at least the binder resin and the colorant is mixed with the aqueous medium containing the surfactant by using a commonly-used mixer, thereby forming the admixture containing the molten and kneaded materials and the aqueous medium containing the surfactant. An amount of the molten and kneaded materials to be added relative to the aqueous medium is not particularly limited, being preferably 3% by weight to 45% by weight and more preferably 5% by weight to 30% by weight of the total weight of the admixture of the molten and kneaded materials and the aqueous medium containing the surfactant.

The molten and kneaded materials and the aqueous medium containing the surfactant may be heated or cooled down when being mixed with each other, but they are usually mixed at room temperature.

The admixture thus obtained of the molten and kneaded materials and the aqueous medium containing the surfactant is coarsely pulverized, and obtained is aqueous slurry (which will be hereinafter referred to as “coarse particle slurry”) containing coarse particles of the molten and kneaded materials. In the embodiment, the high-pressure homogenizer method is used to coarsely pulverize the admixture. The high-pressure homogenizer method is used for forming fine particles through a device in which particles are pulverized under pressure, and composed of a pulverizing step, a depressurizing step, and a cooling step. To be specific, the admixture of the molten and kneaded materials and the aqueous medium containing the surfactant is brought through a nozzle for pulverization under pressure of 15 MPa or more and 120 MPa or less and at temperature of 10° C. or more and less than the glass transition temperature (Tg) of the binder resin, and the admixture is gradually depressurized to such a pressure level that no bubbles are generated, then being cooled down.

In the pulverizing step, the nozzle for pulverization in the high-pressure homogenizer is used. When the admixture of the molten and kneaded materials and the aqueous medium containing the surfactant is being introduced into the nozzle for pulverization, it is necessary to remove the bubbles which may exist in the admixture or in surfaces of the molten and kneaded materials since the bubbles cause a decrease in the pulverizing efficiency in the nozzle for pulverization. Accordingly, the admixture of the molten and kneaded materials and the aqueous medium containing the surfactant is pressurized and heated when pulverized. Conditions for pressurizing and heating are not particularly limited. The admixture of the molten and kneaded materials and the aqueous medium containing the surfactant are pressurized to, for example, 50 Mpa or more and 120 MPa or less by a pressurizing unit in the high-pressure homogenizer when the admixture is introduced into the nozzle for pulverization. By letting the admixture through the nozzle for pulverization under pressure falling in the above range, the bubbles in the molten and kneaded materials and attached to the surfaces thereof can be given large impact force and therefore removed more efficiently. The pressure less than 15 MPa results in application of small impact force to the bubbles attached to the surfaces of the molten and kneaded materials, thus failing to remove the bubbles from the surfaces of the molten and kneaded materials. The pressure higher than 120 MPa results in a failure to take a balance of a nozzle size and a flow rate of the admixture. When the admixture of the molten and kneaded materials and the aqueous medium containing the surfactant is introduced into the nozzle for pulverization, a temperature of the admixture is set at a temperature of 10° C. or more and less than the glass transition temperature (Tg) of the binder resin. By setting the temperature of the admixture within the above range, the bubbles can be more reliably removed. In the admixture having a temperature higher than the glass transition temperature (Tg) of the binder resin, the molten and kneaded materials aggregate and therefore are unable to be treated.

In the depressurizing step, the heated and pressurized coarse particle slurry obtained in the pulverizing step is depressurized to atmospheric pressure or a pressure level close thereto without generating bubbles. For the depressurizing process, a depressurizing module in the high-pressure homogenizer is used. After the depressurizing step, the coarse particle slurry preferably has a liquid temperature of 10° C. or more and less than the glass transition temperature (Tg) of the binder resin.

In the cooling step, the coarse particle slurry depressurized in the depressurizing step is cooled down to a temperature around 20° C. to 40° C. For the cooling process, a cooler in the high-pressure homogenizer is used.

For the high-pressure homogenizer method, the later-described high-pressure homogenizer is used. The high-pressure homogenizer indicates a device for pulverizing particles under pressure. The usable high-pressure homogenizer includes those available on the market or those disclosed in patent publications. Examples of the commercially available high-pressure homogenizer include chamber-type high-pressure homogenizers such as NANO3000 (trade name) manufactured by Beryu Co., Ltd., MICOFLUIDIZER (trade name) manufactured by Microfluidics Corporation, NANOMIZER (trade name) manufactured by Nanomizer Inc., and ULTIMIZER (trade name) manufactured by Sugino Machine Ltd., HIGH-PRESSURE HOMOGENIZER (trade name) manufactured by Rannie Inc., HIGH-PRESSURE HOMOGENIZER (trade name) manufactured by Sanmaru Machinery Co., Ltd., and HIGH-PRESSURE HOMOGENIZER (trade name) manufactured by Izumi Food Machinery Co., Ltd. Further, examples of the high-pressure homogenizer disclosed in patent publications include a high-pressure homogenizer disclosed in WO03/059497. Among the above homogenizers, preferred is the high-pressure homogenizer disclosed in WO03/059497. As a specific example of the high-pressure homogenizer, NANO3000 (trade name) manufactured by Beryu Co., Ltd., will be explained. Using this device, in the pulverizing step, the admixture of the molten and kneaded materials and the aqueous medium containing the surfactant accumulating in a tank is introduced into the nozzle for pulverization under heat and pressure so that the molten and kneaded materials in the admixture are pulverized into fine resin particles; in the depressurizing step, the pressurized admixture discharged from the nozzle for pulverization is introduced into the depressurizing module and depressurized without generating bubbles; and in the cooling step, the admixture discharged from the depressurizing module is introduced into the cooler and cooled therein, thus resulting in coarse particle slurry. The coarse particle slurry is discharged from an outlet or circulates inside the tank, and treated with a pulverization process of the same kind until particle sizes of the molten and kneaded materials in the admixture become desired level.

Through the coarse pulverization as above, the coarse particle slurry can be obtained from the admixture of the molten and kneaded materials and the aqueous medium containing the surfactant, and a volume average particle size of the coarse particles of the molten and kneaded materials can be preferably in the order of 300 μm and more preferably 5 μm or more and 300 μm or less. The molten and kneaded materials are thus pulverized into particles having the sizes as above whereby efficiency of further particle refinement becomes higher. And at the same time, the coarse pulverization allows for removal of the bubbles attached to the molten and kneaded materials and in the following further particle refinement, the surfaces of coarse particles of the molten and kneaded materials can sufficiently secure working points for the surfactant so that size-controlled fine resin particles can be manufactured stably and efficiently.

The coarse particle slurry containing the coarse particles of molten and kneaded materials obtained as above is further treated in the high-pressure homogenizer method so that the coarse particles of the molten and kneaded materials are formed into fine particles, resulting in aqueous slurry containing fine resin particles (which will be hereinafter referred to as “fine resin particle slurry”). In the present embodiment, the coarse particle slurry containing the coarse particles of the molten and kneaded materials is brought through the nozzle for pulverization under pressure of 120 MPa or more and 250 Mpa or less and at temperature of the glass transition temperature (Tg) of the binder resin or more and 200° C. or less, being thus depressurized gradually to such a pressure level that no bubbles are generated, and being cooled down.

In the pulverizing step, the coarse particle slurry is further pulverized under heat and pressure, which slurry is pretreated with the coarsely pulverizing process and has bubbles removed from the surfaces of coarse particles of the molten and kneaded materials. Fine resin particle slurry is thus obtained. The coarse particle slurry is heated and pressurized by a pressurizing unit and a heating unit in the high-pressure homogenizer. Conditions for pressurizing and heating the coarse particle slurry are not particularly limited and preferably are pressure of 120 MPa or more and 250 MPa or less and temperature of the glass transition temperature (Tg) of the binder resin contained in the coarse particles of the molten and kneaded materials or more and 200° C. or less. It is more preferable that the coarse particle slurry be pressurized at 120 MPa or more and 250 MPa or less and heated at a temperature equal to or higher than the softening temperature (Tm) of the binder resin contained in the coarse particles. It is still more preferable that the coarse particle slurry be pressurized at 120 MPa or more and 250 MPa or less and heated at temperature falling in a range from the softening temperature (Tm) of the binder resin contained in the coarse particles of the molten and kneaded materials to a temperature 25° C. higher than the softening temperature (Tm). Note that the softening temperature (Tm) herein indicates half a softening temperature of the binder resin determined by a flow tester. In the case where the coarse particles of the molten and kneaded materials contain two or more binder resins, the softening temperature (Tm) herein indicates the highest softening temperature among the softening temperatures of the two or more binder resins. The pressure less than 120 MPa will generate small shear force, possibly failing to develop sufficient pulverization. The pressure exceeding 250 MPa will excessively increase a degree of risk in an actual production line, thus being unrealistic.

In the depressurizing step, the heated and pressurized fine resin particle slurry obtained in the pulverizing step is depressurized to atmospheric pressure or a pressure level close thereto without generating bubbles. For the depressurizing process, the depressurizing module in the hiqh-pressure homogenizer is used. After the depressurizing step, a liquid temperature of the fine resin particle slurry is preferably the glass transition temperature (Tg) of the binder resin or more and 200° C. or less, and more preferably a temperature falling in a range from 60° C. to a temperature 60° C. higher than the softening temperature (Tm).

In the cooling step, the fine resin particle slurry having the liquid temperature falling in the approximate range from 60° C. to a temperature 60° C. higher than the softening temperature (Tm) which slurry has been depressurized in the depressurizing step, is cooled down, resulting in fine resin particle slurry having a temperature around 20° C. to 40° C. For the cooling process, the cooler in the high-pressure homogenizer is used.

Through the steps as above, the fine resin particle slurry is prepared in which the fine resin particles are finely dispersed in the aqueous medium. A volume average particle size of the obtained fine resin particles is preferably 0.2 μm to 3.0 μm. The fine resin particles having a volume average particle size smaller than 0.2 μm are smaller in size than the colorant and release agent to be dispersed therein and therefore unable to contain the colorant and release agent. The fine resin particles having a volume average particle size larger than 3.0 μm are hard to form a toner which exhibits a narrow particle size distribution and has a volume average particle size of 5 μm to 6 μm.

[Aggregating Step]

At the aggregating step S2, an aggregating agent is added to the dispersion (A) in which at least the fine resin particles and the fine colorant particles are dispersed in the aqueous medium, or the dispersion (B) in which the fine coloring resin particles containing at least the binder resin and the colorant are dispersed in the aqueous medium to aggregate the fine resin particles by using a granulating device including an agitating container storing the fine resin particle slurry and an agitating part being disposed inside the agitating container and agitating the fine resin particle slurry, thereby forming slurry in which aggregates (aggregated particles) of the fine resin particles are dispersed in the aqueous medium containing the surfactant. The slurry thus obtained will be hereinafter referred to as “particle-aggregated slurry”.

For the aggregating agent, a cationic dispersant or polyvalent metal salt can be used, for example. Preferable examples of the cationic dispersant include an alkyltrimethyl ammonium cationic dispersant, an alkylamide amine cationic dispersant, an alkyldimethylbenzyl ammonium cationic dispersant, a cationized polysaccharide cationic dispersant, an alkylbetaine cationic dispersant, an alkylamide betaine cationic dispersant, a sulfobetaine cationic dispersant, an amineoxide cationic dispersant and metal salt. Examples of the metal salt include chlorides and sulfates of sodium, potassium, calcium, magnesium, etc.

The polyvalent metal salt used as the aggregating agent is salt of a divalent or higher valent metal. Preferable examples of the divalent or higher valent metal include alkali earth metals such as magnesium, calcium, and barium; and an element of thirteen group in the periodic series such as aluminum, among which magnesium and aluminum are preferred. Specific examples of the salt of divalent or higher valent metal include magnesium-sulfate, aluminum sulfate, barium chloride, magnesium chloride, calcium chloride, aluminum chloride, aluminum hydroxide, and magnesium hydroxide.

Among the above aggregating agents, sodium chloride is preferred owing to its relatively high solubility to water and its slow aggregating speed. A usage of the aggregating agent is preferably 0.5 part by weight to 20 parts by weight, more preferably 0.5 part by weight to 18 parts by weight, and particularly preferably 1.0 part by weight to 18 parts by weight based on 100 parts by weight of the fine resin particle slurry. The usage of the aggregating agent less than 0.5 part by weight may be not enough to sufficiently exert its aggregating effect, and the usage of the aggregating agent more than 20 parts by weight may cause excessive aggregating, possibly forming too large aggregated particles.

For the granulating device including the agitating container storing the fine resin particle slurry and the agitating part being disposed inside the agitating container and agitating the fine resin particle slurry, it is preferable to use an emulsifying device or dispersing device capable of giving mechanical one-way shear force. Using the device, the aggregated particles having more uniform sizes and shapes can be formed. Specific examples of the emulsifying device and dispersing device include: a batch-type emulsifying device such as ULTRA TURRAX (trade name) manufactured by IKA Japan K.K., POLYTRON HOMOGENIZER (trade name) manufactured by Kinematica AG, T.K. AUTO HOMOMIXER (trade name) manufactured by PRIMIX Corporation, or MAXBLEND (trade name) manufactured by Sumitomo Heavy Industries, Ltd.; a continuous-type emulsifying device such as EBARAMILDER (trade name) manufactured by Ebara Corporation, T.K. PIPELINE HOMOMIXER (trade name) manufactured by PRIMIX Corporation, T.K. HOMOMIC LINE FLOW (trade name) manufactured by PRIMIX Corporation, FILMICS (trade name) manufactured by PRIMIX Corporation, COLLOID MILL (trade name) manufactured by Shinko Pantec Co., Ltd., SLUSHER (trade name) manufactured by Mitsui Miike Kakoki Co., Ltd., TRIGONAL WET GRINDER (trade name) manufactured by Mitsui Miike Kakoki Co., Ltd., CAVITRON (trade name) manufactured by Eurotec, Ltd., FINE FLOW MILL (trade name) manufactured by Taiheiyo Kiko Co., Ltd.; CLEARMIX (trade name) manufactured by M Technique Co., Ltd.; and FILMICS (trade name) manufactured by PRIMIX Corporation.

In mixing the fine resin particle slurry and the aggregating agent, values of agitating speed and agitating temperature of the granulating device may be appropriately selected so as to obtain toner particles having desired sizes, particle size distribution, and shapes. A length of an agitating time may be appropriately determined according to various conditions such as kinds and density of the binder resin, colorant, other toner additive components, an aggregating agent, and dispersant.

[Washing Step]

In the washing step S3, aggregated particles contained in the particle-aggregated slurry are washed after cooling of the particle-aggregated slurry. The aggregated particles are washed in order to remove the surfactant, the dispersant, the viscosity improver, and impurities thereof. The surfactant, the dispersant, the viscosity improver, and impurities thereof remaining in the aggregated particles may result in toner particles having unstable chargeability. Further, such toner particles may have charges decreasing by the influence of water in the air.

One example of manners for washing the aggregated particles may be such that water is added to the particle-aggregated slurry, and the water-added particle-aggregated slurry is agitated to centrifugally separate a supernatant solution which is then removed. The washing process of the aggregated particles just described is preferably repeated until electric conductivity of the supernatant solution measured by an electric conductivity meter or the like device becomes 100 μS/cm or less, preferably 10 μS/cm or less. By so doing, the surfactant, the dispersant, the viscosity improver, and impurities thereof can be more reliably prevented from remaining so that the toner particles can have more uniform and stable chargeability.

It is preferred that the water used for the washing process has electric conductivity of 20 μS/cm or less. Such washing water can be prepared, for example, by an activated carbon method, an ion-exchange method, a distillation method, a reverse osmosis method, or the like method. Of these methods, two or more methods may be combined to prepare the water. Either of the batch-type or continuous type may be employed for the water washing of the aggregated particles. A temperature of the washing water is not particularly limited and preferably 10° C. or more and the glass transition, temperature (Tg) or less. In the case where the molten and kneaded materials contain two or more binder resins, the glass transition temperature (Tg) herein indicates the lowest glass transition temperature (Tg) among the glass transition temperatures (Tg) of the two or more binder resins.

[Separating Step]

In the separating step S4, the aggregated particles are removed and thus collected from the admixture of the aqueous medium containing the washed aggregated particles. A method of separating the aggregated particles from the aqueous medium is not particularly limited and may be filtration, suction filtration, centrifugal separation, or the like method.

[Drying Step]

In the drying step S5, the aggregated particles already washed and separated are dried. A method of drying the aggregated particles is not particularly limited and may be a freeze-drying method, an airflow-drying method, or the like method. After the aggregated particles are dried in the step S5, the manufacture of the toner particles comes to an end.

To the toner particles thus obtained, an external additive may be added as needed. For the external additive, those customarily used in this relevant filed can be used including, for example, fine inorganic powder such as fine silica powder, fine titanium oxide powder, or fine alumina powder. For the purpose of hydrophobizing the toner or controlling chargeability thereof, the above fine inorganic powders are preferably treated with a treatment agent such as silicone varnish, denatured silicone varnish of various types, silicone oil, denatured silicone oil of various types, a silane coupling agent, a silane coupling agent having a functional group, or other organic silicon compound. The treatment agents may be used each alone, or two or more of the treatment agents may be used in combination. Such external additives may be used each alone, or two or more of the external additives may be used in combination. An amount of the external additive to be added is preferably 5 parts by weight or less based on 100 parts by weight of the toner particles in consideration of a charge amount necessary for the toner, influence on a photoreceptor wear caused by addition of the external additive, environmental characteristics of the toner, and the like element.

It is preferred that a number average particle size of primary particles of the external additive be 10 nm to 500 nm. The use of the external additive having such particle sizes makes it easier to exert an effect of enhancing the fluidity of the toner.

The toner formed of toner particles to which the external additive has been added as above can be directly used in form of one-component developer, or alternatively mixed with a carrier and thus used in form of two-component developer. In the two-component developer, magnetic particles may be used for the carrier, for example. Specific examples of the magnetic particles include metals such as iron, ferrite, and magnetite; and alloys composed of the metals just cited and metals such as aluminum or lead. Among these examples, ferrite is preferred.

Further, the carrier can be a resin-coated carrier in which the magnetic particles are coated with resin, or a dispersed-in-resin carrier in which the magnetic particles are dispersed in resin. The resin for coating the magnetic particles is not particularly limited and includes, for example, olefin-based resin, styrene-based resin, styrene-based/acrylic resin, silicone-based resin, ester-based resin, and fluorine-containing polymer-based resin, for example. The resin used for the dispersed-in-resin carrier is not particularly limited either and includes styrene acrylic resin, polyester resin, fluorine-based resin, and phenol resin, for example.

A shape of the carrier is preferably spherical or oblong. Further, a particle size of the carrier is not particularly limited. In consideration of enhancement in image quality, the particle size of the carrier is preferably 10 μm to 100 μm and more preferably 20 μm to 60 μm. Furthermore, resistivity of the carrier is preferably 10⁸ Ω·cm or more and more preferably 10¹² Ω·cm or more. The resistivity of the carrier is a current value obtained in a manner that the carrier is put in a container having a sectional area of 0.50 cm² followed by tapping, and a load of 1 kg/cm² is then applied to the particles put in the container, thereafter being subjected to application of voltage which generates an electric field of 1,000 V/cm between the load and a bottom electrode. When the resistivity is small, application of bias voltage to a developing sleeve will cause charges to be injected to the carrier, which makes the carrier particles be easily attached to the photoreceptor. Further, in this case, breakdown of the bias voltage occurs more easily.

Magnetization intensity (maximum magnetization) of the carrier is preferably 10 emu/g to 60 emu/g and more preferably 15 emu/g to 40 emu/g. The magnetization intensity depends on magnetic flux density of a developing roller. Under a condition that the developing roller has normal magnetic flux density, the magnetization intensity less than 10 emu/g will lead to a failure to exercise magnetic binding force, which may cause the carrier to be spattered. When the magnetization intensity exceeds 60 emu/g, it becomes difficult to keep a noncontact state with an image bearing member in a noncontact development where brush of the carrier is too high, and in a contact development, sweeping patterns may appear more frequently in a toner image.

A usage between the toner and the carrier contained in the two-component developer may be appropriately selected according to kinds of the toner and carrier without particular limitation. To take the case of the resin-coated carrier (having density of 5 g/cm² to 8 g/cm²) as an example, it is only required that the use amount of the toner contained in the developer is 2% by weight to 30% by weight and preferably 2% by weight to 20% by weight based on a total amount of the developer. In the two-component developer, a preferable coverage of the toner over the carrier is 40% to 80%.

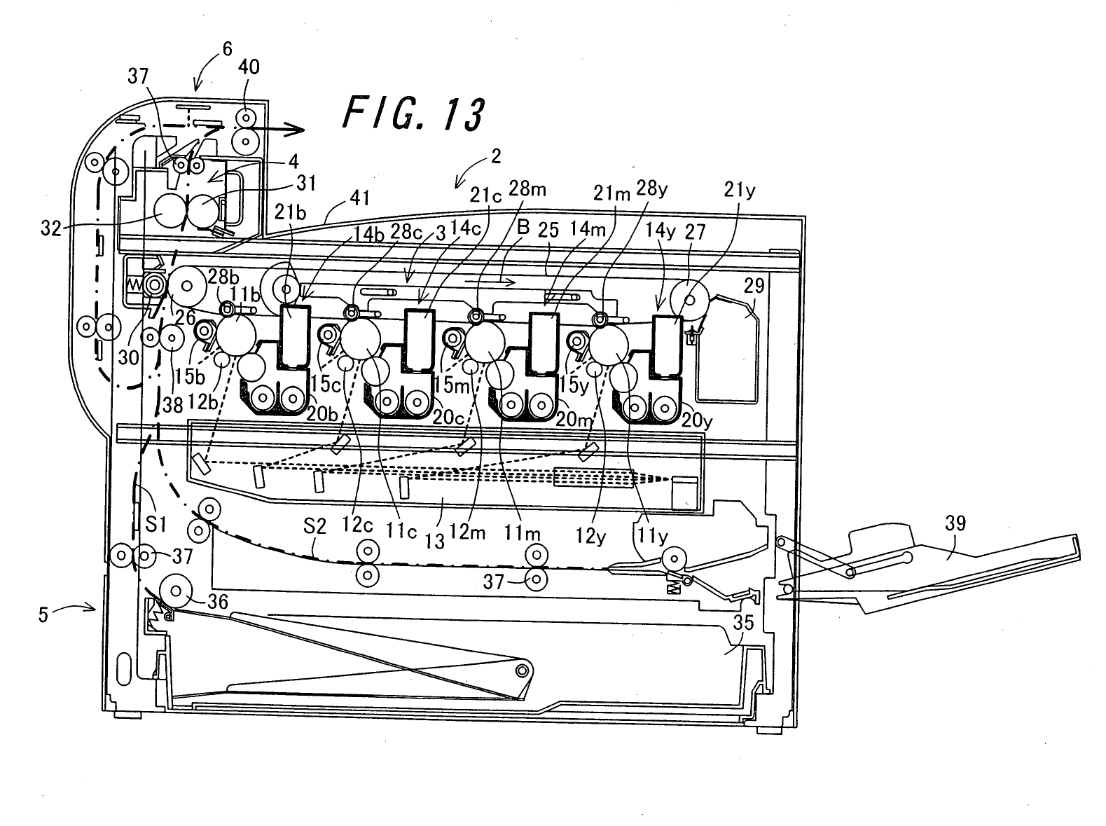

FIG. 13 is a sectional view schematically showing a configuration of an image forming apparatus 1 according to an embodiment of the invention. The image forming apparatus is a multifunctional system which combines a copier function, a printer function, and a facsimile function. In the image forming apparatus, according to image information transmitted thereto, a full-color or black-and-white image is formed on a recording medium. To be specific, three print modes, i.e., a copier mode, a printer mode, and a facsimile mode are available in the image forming apparatus, one of which print modes is selected by a control section (not shown) in response to an operation input given by an operating section (not shown) or a print job given by a personal computer, a mobile computer, an information record storage medium, or an external equipment having a memory unit. The image forming apparatus 1 includes a toner image forming section 2, a transferring section 3, a fixing section 4, a recording medium supplying section 5, and a discharging section 6. In accordance with image information of respective colors of black (b), cyan (c), magenta (m), and yellow (y) which are contained in color image information, there are provided respectively four sets of the components constituting the toner image forming section 2 and some parts of the components contained in the transfer section 3. The four sets of respective components provided for the respective colors are distinguished herein by giving alphabets indicating the respective colors to the end of the reference numerals, and in the case where the sets are collectively referred to, only the reference numerals are shown.

The toner image forming section 2 includes a photoreceptor drum 11, a charging section 12, an exposure unit 13, a developing device t4, and a cleaning unit 15. The charging section 12, the developing device 14, and the cleaning unit 15 are disposed in the order just stated around the photoreceptor drum 11. The charging section 12 is disposed below the developing device 14 and the cleaning unit 15 when viewed in a vertical direction.

The photoreceptor drum 11 is rotatably supported around an axis thereof by a driving mechanism (not shown), and includes a conductive substrate and a photosensitive layer formed on a surface of the conductive substrate although not shown. The conductive substrate may be formed into various shapes such as a cylindrical shape, a circular columnar shape, and a thin film sheet shape. Among these shapes, the cylindrical shape is preferred. The conductive substrate is formed of a conductive material. As the conductive material, those customarily used in the relevant field can be used including, for example, metals such as aluminum, copper, brass, zinc, nickel, stainless steel, chromium, molybdenum, vanadium, indium, titanium, gold, and platinum; alloys formed of two or more of the metals; a conductive film in which a conductive layer containing one or two or more of aluminum, aluminum alloy, tin oxide, gold, indium oxide, etc. is formed on a film-like substrate such as synthetic resin film, metal film, and paper; and a resin composition containing conductive particles and/or conductive polymers. As the film-like substrate used for the conductive film, a synthetic resin film is preferred and a polyester film is particularly preferred. Further, as the method of forming the conductive layer in the conductive film, vapor deposition, coating, etc. are preferred.

The photosensitive layer is formed, for example, by stacking a charge generation layer containing a charge generating substance, and a charge transport layer containing a charge transporting substance. In this case, an undercoat layer is preferably formed between the conductive substrate and the charge generation layer or the charge transport layer. When the undercoat layer is provided, the flaws and irregularities present on the surface of the conductive substrate are covered, leading to advantages such that the photosensitive layer has a smooth surface, that chargeability of the photosensitive layer can be prevented from degrading during repetitive use, and that the charging property of the photosensitive layer can be enhanced under a low temperature and/or low humidity circumstance. Further, the photosensitive layer may be a laminated photoreceptor having a highly-durable three-layer structure in which a photoreceptor surface-protecting layer is provided on the top layer.

The charge generation layer contains as a main ingredient a charge generating substance that generates charges under irradiation of light, and optionally contains known binder resin, plasticizer, sensitizer, etc. As the charge generating substance, materials used customarily in the relevant field can be used including, for example, perylene pigments such as perylene imide and perylenic acid anhydride; polycyclic quinone pigments such as quinacridone and anthraquinone; phthalocyanine pigments such as metal and non-metal phthalocyanines, and halogenated non-metal phthalocyanines; squalium dyes; azulenium dyes; thiapylirium dyes; and azo pigments having carbazole skeleton, styrylstilbene skeleton, triphenylamine skeleton, dibenzothiophene skeleton, oxadiazole skeleton, fluorenone skeleton, bisstilbene skeleton, distyryloxadiazole skeleton, or distyryl carbazole skeleton. Among those charge generating substances, non-metal phthalocyanine pigments, oxotitanyl phthalocyanine pigments, bisazo pigments containing fluorene rings and/or fluorenone rings, bisazo pigments containing aromatic amines, and trisazo pigments have high charge generation ability and are suitable for forming a highly-sensitive photosensitive layer. The charge generating substances may be used each alone, or two or more of the charge generating substances may be used in combination. The content of the charge generating substance is not particularly limited, and preferably from 5 parts by weight to 500 parts by weight and more preferably from 10 parts by weight to 200 parts by weight based on 100 parts by weight of binder resin in the charge generation layer. Also as the binder resin for charge generation layer, materials used customarily in the relevant field can be used including, for example, melamine resin, epoxy resin, silicone resin, polyurethane, acrylic resin, vinyl chloride-vinyl acetate copolymer resin, polycarbonate, phenoxy resin, polyvinyl butyral, polyallylate, polyamide, and polyester. The binder resins may be used each alone or, optionally, two or more of the resin may be used in combination.

The charge generation layer can be formed by dissolving or dispersing an appropriate amount of a charge generating substance, binder resin and, optionally, a plasticizer, a sensitizer, etc. respectively in an appropriate organic solvent which is capable of dissolving or dispersing the ingredients described above, to thereby prepare a coating solution for charge generation layer, and then applying the coating solution for charge generation layer to the surface of the conductive substrate, followed by drying. The thickness of the charge generation layer obtained in this way is not particularly limited, and preferably from 0.05 μm to 5 μm and more preferably from 0.1 μm to 2.5 μm.

The charge transport layer stacked over the charge generation layer contains as essential ingredients a charge transporting substance having an ability of receiving and transporting charges generated from the charge generating substance, and binder resin for charge transport layer, and optionally contains known antioxidant, plasticizer, sensitizer, lubricant, etc. As the charge transporting substance, materials used customarily in the relevant field can be used including, for example: electron donating materials such as poly-N-vinyl carbazole, a derivative thereof, poly-γ-carbazolyl ethyl glutamate, a derivative thereof, a pyrene-formaldehyde condensation product, a derivative thereof, polyvinylpyrene, polyvinyl phenanthrene, an oxazole derivative, an oxadiazole derivative, an imidazole derivative, 9-(p-diethylaminostyryl)anthracene, 1,1-bis(4-dibenzylaminophenyl)propane, styrylanthracene, styrylpyrazoline, a pyrazoline derivative, phenyl hydrazones, a hydrazone derivative, a triphenylamine compound, a tetraphenyldiamine compound, a triphenylmethane compound, a stilbene compound, and an azine compound having 3-methyl-2-benzothiazoline ring; and electron accepting materials such as a fluorenone derivative, a dibenzothiophene derivative, an indenothiophene derivative, a phenanthrenequinone derivative, an indenopyridine derivative, a thioquisantone derivative, a benzo[c]cinnoline derivative, a phenazine oxide derivative, tetracyanoethylene, tetracyanoquinodimethane, promanyl, chloranyl, and benzoquinone. The charge transporting substances may be used each alone, or two or more of the charge transporting substances may be used in combination. The content of the charge transporting substance is not particularly limited, and preferably from 10 parts by weight to 300 parts by weight and more preferably from 30 parts by weight to 150 parts by weight based on 100 parts by weight of the binder resin in the charge transport layer. As the binder resin for charge transport layer, it is possible to use materials which are used customarily in the relevant field and capable of uniformly dispersing the charge transporting substance, including, for example, polycarbonate, polyallylate, polyvinylbutyral, polyamide, polyester, polyketone, epoxy resin, polyurethane, polyvinylketone, polystyrene, polyacrylamide, phenolic resin, phenoxy resin, polysulfone resin, and copolymer resin thereof. Among those materials, in view of the film forming property, and the wear resistance, electrical characteristics etc. of the obtained charge transport layer, it is preferable to use, for example, polycarbonate which contains bisphenol Z as the monomer ingredient (hereinafter referred to as “bisphenol Z polycarbonate”), and an admixture of bisphenol Z polycarbonate and other polycarbonate. The binder resin may be used each alone, or two or more of the binder resin may be used in combination.

The charge transport layer preferably contains an antioxidant together with the charge transporting substance and the binder resin for charge transport layer. Also for the antioxidant, materials used customarily in the relevant field can be used including, for example, Vitamin E, hydroquinone, hindered amine, hindered phenol, paraphenylene diamine, arylalkane and derivatives thereof, an organic sulfur compound, and an organic phosphorus compound. The antioxidants may be used each alone, or two or more of the antioxidants may be used in combination. The content of the antioxidant is not particularly limited, and is 0.01% by weight to 10% by weight and preferably 0.05% by weight to 5% by weight of the total amount of the ingredients constituting the charge transport layer. The charge transport layer can be formed by dissolving or dispersing an appropriate amount of a charge transporting substance, binder resin and, optionally, an antioxidant, a plasticizer, a sensitizer, etc. respectively in an appropriate organic solvent which is capable of dissolving or dispersing the ingredients described above, to thereby prepare a coating solution for charge transport layer, and applying the coating solution for charge transport layer to the surface of a charge generation layer followed by drying. The thickness of the charge transport layer obtained in this way is not particularly limited, and preferably 10 μm to 50 μm and more preferably 15 μm to 40 μm. Note that it is also possible to form a photosensitive layer in which a charge generating substance and a charge transporting substance are present in one layer. In this case, the kind and content of the charge generating substance and the charge transporting substance, the kind of the binder resin, and other additives may be the same as those in the case of forming separately the charge generation layer and the charge transport layer.

In the embodiment, there is used a photoreceptor drum which has an organic photosensitive layer as described above containing the charge generating substance and the charge transporting substance. It is, however, also possible to use, instead of the above photoreceptor drum, a photoreceptor drum which has an inorganic photosensitive layer containing silicon or the like.

The charging section 12 faces the photoreceptor drum 11 and is disposed away from the surface of the photoreceptor drum 11 when viewed in a longitudinal direction of the photoreceptor drum 11. The charging section 12 charges the surface of the photoreceptor drum 11 so that the surface of the photoreceptor drum 11 has predetermined polarity and potential. As the charging section 12, it is possible to use a charging brush type charger, a charger type charger, a saw tooth type charger, an ion-generating device, etc. Although the charging section 12 is disposed away from the surface of the photoreceptor drum 11 in the embodiment, the configuration is not limited thereto. For example, a charging roller may be used as the charging section 12, and the charging roller may be disposed in pressure-contact with the photoreceptor drum 11. It is also possible to use a contact-charging type charger such as a charging brush or a magnetic brush.

The exposure unit 13 is disposed so that light corresponding to respective color information emitted from the exposure unit 13 passes between the charging section 12 and the developing section 14 and reaches the surface of the photoreceptor drum 11. The exposure unit 13 converts the image information into light corresponding to respective color information of black (b), cyan (c), magenta (m), and yellow (y), and the surface of the photoreceptor drum 11 which has been evenly charged by the charging section 12, is exposed to the light corresponding to the respective color information to thereby form an electrostatic latent image on the surface of the photoreceptor drum 11. As the exposure unit 13, it is possible to use a laser scanning unit having a laser-emitting portion and a plurality of reflecting mirrors. The other usable examples of the exposure unit 13 may include an LED array and a unit in which a liquid-crystal shutter and a light source are appropriately combined with each other.

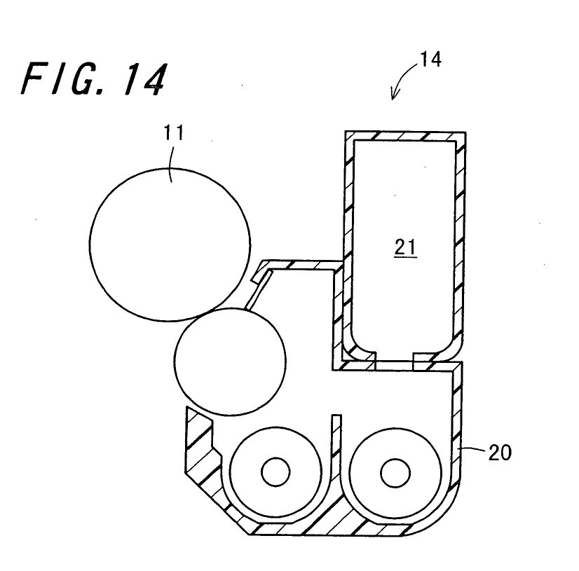

FIG. 14 is a sectional view schematically showing a configuration of the developing device 14 according to an embodiment of the invention.

The developing section 14 includes a developer tank 20 and a toner hopper 21. The developer tank 20 is a container-shaped member which is disposed so as to face the surface of the photoreceptor drum 11 and used to supply a toner to an electrostatic latent image formed on the surface of the photoreceptor drum 11 so as to develop the electrostatic latent image into a visualized image, i.e. a toner image. The developer tank 20 contains in an internal space thereof the toner, and rotatably supports roller members such as a developing roller, a supplying roller, and an agitating roller, or screw members, which roller or screw members are contained in the developer tank 20. The developer tank 20 has an opening in a side face thereof opposed to the photoreceptor drum 11. The developing roller is rotatably provided at such a position as to face the photoreceptor drum 11 through the opening just stated. The developing roller is a roller-shaped member for supplying a toner to the electrostatic latent image on the surface of the photoreceptor drum 11 in a pressure-contact area or most-adjacent area between the developing roller and the photoreceptor drum 11. In supplying the toner, to a surface of the developing roller is applied potential whose polarity is opposite to polarity of the potential of the charged toner, which serves as development bias voltage (hereinafter referred to simply as “development bias”). By so doing, the toner on the surface of the developing roller is smoothly supplied to the electrostatic latent image. Furthermore, an amount of the toner being supplied to the electrostatic latent image (which amount is referred to as “toner attachment amount”) can be controlled by changing a value of the development bias. The supplying roller is a roller-shaped member which is rotatably disposed so as to face the developing roller and used to supply the toner to the vicinity of the developing roller. The agitating roller is a roller-shaped member which is rotatably disposed so as to face the supplying roller and used to feed to the vicinity of the supplying roller the toner which is newly supplied from the toner hopper 21 into the developer tank 20. The toner hopper 21 is disposed so as to communicate a toner replenishment port (not shown) formed in a vertically lower part of the toner hopper 21, with a toner reception port (not shown) formed in a vertically upper part of the developer tank 20. The toner hopper 21 replenishes the developer tank 20 with the toner according to toner consumption. Further, it may be possible to adopt such configuration that the developer tank 20 is replenished with the toner supplied directly from a toner cartridge of each color without using the toner hopper 21.

The cleaning unit 15 removes the toner which remains on the surface of the photoreceptor drum 11 after the toner image has been transferred to the recording medium, and thus cleans the surface of the photoreceptor drum 11. In the cleaning unit 15, a platy member is used such as a cleaning blade. In the image forming apparatus 1 according to the embodiment of the invention, an organic photoreceptor drum is mainly used as the photoreceptor drum 11. A surface of the organic photoreceptor drum contains a resin component as a main ingredient and therefore tends to be degraded by chemical action of ozone which is generated by corona discharging of the charging device. The degraded surface part is, however, worn away by abrasion through the cleaning unit 15 and thus removed reliably, though gradually. Accordingly, the problem of the surface degradation caused by the ozone, etc. is actually solved, and it is thus possible to stably maintain the potential of charges given by the charging operation over a long period of time. Although the cleaning unit 15 is provided in the embodiment, no limitation is imposed on the configuration and the cleaning unit 15 does not have to be provided.

In the toner image forming section 2, signal light corresponding to the image information is emitted from the exposure unit 13 to the surface of the photoreceptor drum 11 which has been evenly charged by the charging section 12, thereby forming an electrostatic latent image; the toner is then supplied from the developing section 14 to the electrostatic latent image, thereby forming a toner image; the toner image is transferred to an intermediate transfer belt 25; and the toner which remains on the surface of the photoreceptor drum 11 is removed by the cleaning unit 15. A series of toner image forming operations just described are repeatedly carried out.

The transferring section 3 is disposed above the photoreceptor drum 11 as viewed in a vertical direction thereof, and includes the intermediate transfer belt 25, a driving roller 26, a driven roller 27, an intermediate transferring roller 28 (b, c, m, y), a transfer belt cleaning unit 29, and a transferring roller 30. The intermediate transfer belt 25 is an endless belt stretched between the driving roller 26 and the driven roller 27, thereby forming a loop-shaped travel path. The intermediate transfer belt 25 rotates in an arrow B direction. When the intermediate transfer belt 25 passes by the photoreceptor drum 11 in contact therewith, the transfer bias whose polarity is opposite to the polarity of the charged toner on the surface of the photoreceptor drum 11 is applied from the intermediate transferring roller 28 which is disposed opposite to the photoreceptor drum 11 across the intermediate transfer belt 25, with the result that the toner image formed on the surface of the photoreceptor drum 11 is transferred onto the intermediate transfer belt 25. In the case of a multicolor image, the toner images of respective colors formed by the respective photoreceptor drums 11 are sequentially transferred onto the intermediate transfer belt 25 and combined thereon, thus forming a multicolor image. The driving roller 26 can rotate around an axis thereof with the aid of a driving mechanism (not shown), and the rotation of the driving roller 26 drives the intermediate transfer belt 25 to rotate in the arrow B direction. The driven roller 27 can be driven to rotate by the rotation of the driving roller 26, and imparts constant tension to the intermediate transfer belt 25 so that the intermediate transfer belt 25 does not go slack. The intermediate transferring roller 28 is disposed in pressure-contact with the photoreceptor drum 11 across the intermediate transfer belt 25, and capable of rotating around its own axis by a driving mechanism (not shown). The intermediate transfer belt 28 is connected to a power source (not shown) for applying the transfer bias as described above, and has a function of transferring the toner image formed on the surface of the photoreceptor drum 11 to the intermediate transfer belt 25. The transfer belt cleaning unit 29 is disposed opposite to the driven roller 27 across the intermediate transfer belt 25 so as to come into contact with an outer circumferential surface of the intermediate transfer belt 25. The toner which is attached to the intermediate transfer belt 25 by contact with the photoreceptor drum 11 may cause contamination on a reverse side of a recording medium. This is why the transfer belt cleaning unit 29 removes and collects the toner on the surface of the intermediate transfer belt 25. The transferring roller 30 is disposed in pressure-contact with the driving roller 26 across the intermediate transfer belt 25, and capable of rotating around its own axis by a driving mechanism (not shown). In a pressure-contact area (a transfer nip area) between the transferring roller 30 and the driving roller 26, a toner image which has been carried by the intermediate transfer belt 25 and thereby conveyed to the pressure-contact area is transferred onto a recording medium fed from the later-described recording medium supplying section 5. The recording medium carrying the toner image is fed to the fixing section 4. In the transferring section 3, the toner image is transferred from the photoreceptor drum 11 onto the intermediate transfer belt 25 in the pressure-contact area between the photoreceptor drum 11 and the intermediate transferring roller 28, and by the intermediate transfer belt 25 rotating in the arrow B direction, the transferred toner image is conveyed to the transfer nip area where the toner image is transferred onto the recording medium.

The fixing section 4 is provided downstream of the transfer section 3 along a conveyance direction of the recording medium, and contains a fixing roller 31 and a pressurizing roller 32. The fixing roller 31 can rotate by a driving mechanism (not shown), and heats the toner constituting an unfixed toner image carried on the recording medium so that the toner is fused to be fixed on the recording medium. Inside the fixing roller 31 is provided a heating portion (not shown). The heating portion heats the heating roller 31 so that a surface of the heating roller 31 has a predetermined temperature (heating temperature). For the heating portion, a heater, a halogen lamp, and the like device can be used, for example. The heating portion is controlled by the later-described fixing condition controlling portion. Detailed descriptions will be hereinafter given regarding the control of the heating temperature conducted by the fixing condition controlling portion. In the vicinity of the surface of the fixing roller 31 is provided a temperature detecting sensor which detects a surface temperature of the fixing roller 31. A result detected by the temperature detecting sensor is written to a memory portion of the later-described control unit. The pressurizing roller 32 is disposed in pressure-contact with the fixing roller 31, and supported so as to be rotatably driven by the rotation of the pressurizing roller 32. The pressurizing roller 32 helps the toner image to be fixed onto the recording medium by pressing the toner and the recording medium when the toner is fused to be fixed on the recording medium by the fixing roller 31. A pressure-contact portion between the fixing roller 31 and the pressurizing roller 32 is a fixing nip area. In the fixing section 4, the recording medium onto which the toner image has been transferred in the transfer section 3 is nipped by the fixing roller 31 and the pressurizing roller 32 so that when the recording medium passes through the fixing nip area, the toner mage is pressed and thereby fixed on the recording medium under heat, whereby an image is formed.

The recording medium supplying section 5 includes an automatic paper feed tray 35, a pickup roller 36, a conveying roller 37, a registration roller 38, and a manual paper feed tray 39. The automatic paper feed tray 35 is disposed in a vertically lower part of the image forming apparatus 1 and in form of a container-shaped member for storing the recording mediums. Examples of the recording medium include plain paper, color copy paper, sheets for over head projector, and post cards. The pickup roller 36 takes out sheet by sheet the recording mediums stored in the automatic paper feed tray 35, and feeds the recording mediums to a paper conveyance path S1. The conveying roller 37 is a pair of roller members disposed in pressure-contact with each other, and conveys the recording medium to the registration roller 38. The registration roller 38 is a pair of roller members disposed in pressure-contact with each other, and feeds to the transfer nip area the recording medium fed from the conveying roller 37 in synchronization with the conveyance of the toner image carried on the intermediate transfer belt 25 to the transfer nip area. The manual paper feed tray 39 is a device storing recording mediums which are different from the recording mediums stored in the automatic paper feed tray 35 and may have any shape and which are to be taken into the image forming apparatus 1. The recording medium taken in from the manual paper feed tray 39 passes through a paper conveyance path S2 by use of the conveying roller 37, thereby being fed to the registration roller 38. In the recording medium supplying section 5, the recording medium supplied sheet by sheet from the automatic paper feed tray 35 or the manual paper feed tray 39 is fed to the transfer nip area in synchronization with the conveyance of the toner image carried on the intermediate transfer belt 25 to the transfer nip area.

The discharging section 6 includes the conveying roller 37, a discharging roller 40, and a catch tray 41. The conveying roller 37 is disposed downstream of the fixing nip area along the paper conveyance direction, and conveys toward the discharging roller 40 the recording medium onto which the image has been fixed by the fixing section 4. The discharging roller 40 discharges the recording medium onto which the image has been fixed, to the catch tray 41 disposed on a vertically upper surface of the image forming apparatus 1. The catch tray 41 stores the recording medium onto which the image has been fixed.

The image forming apparatus 1 includes a control unit (not shown). The control unit is disposed, for example, in an upper part of an internal space of the image forming apparatus 1, and contains a memory portion, a computing portion, and a control portion. To the memory portion of the control unit are input, for example, various set values obtained by way of an operation panel (not shown) disposed on the upper surface of the image forming apparatus 1, results detected from a sensor (not shown) etc. disposed in various portions inside the image forming apparatus 1, and image information obtained from an external equipment. Further, programs for operating various functional elements are written. Examples of the various functional elements include a recording medium determining portion, an attached amount controlling portion, and a fixing condition controlling portion. For the memory portion, those customarily used in the relevant filed can be used including, for example, a read only memory (ROM), a random access memory (RAM), and a hard disc drive (HDD). For the external equipment, it is possible to use electrical and electronic devices which can form or obtain the image information and which can be electrically connected to the image forming apparatus 1. Examples of the external equipment include a computer, a digital camera, a television, a video recorder, a DVD recorder, an HDVD, a blu-ray disc recorder, a facsimile machine, and a mobile computer. The computing portion of the control unit takes out the various data (such as an image formation order, the detected result, and the image information) written in the memory portion and the programs for various functional elements, and then makes various determinations. The control portion of the control unit sends to a relevant device a control signal in accordance with the result determined by the computing portion, thus performing control on operations. The control portion and the computing portion include a processing circuit which is achieved by a microcomputer, a microprocessor, etc. having a central processing unit. The control unit contains a main power source as well as the above-stated processing circuit. The power source supplies electricity to not only the control unit but also respective devices provided inside the image forming apparatus 1.

Using the toner of the embodiment having both of cleaning property and transferring property, a high-quality image can be formed.

Hereinafter, the invention will be specifically described with reference to Examples and Comparative examples to which the invention is not particularly limited within its scope. In the following descriptions, “part” indicates “part by weight”, and “%” indicates “% by weight”, unless otherwise specified.

[Method of Measuring Values of Properties]

Values of properties in Examples and Comparative examples are measured as follows.

[Glass Transition Temperature (Tg)]

Using a differential scanning calorimeter: DSC220 (trade name) manufactured by Seiko Electronics Inc., 1 g of a sample (which is carboxyl group-containing resin or water-soluble resin) was heated at a temperature of which increase rate was 10° C./min based on Japanese Industrial Standards (JIS) K7121-1987, thus obtaining a DSC curve. A straight line was drawn toward a low-temperature side extendedly from a base line on the high-temperature side of an endothermic peak corresponding to glass transition of the DSC curve which had been obtained as above. A tangent line was also drawn at a point where a gradient thereof was maximum against a curve extending from a rising part to a top of the peak. A temperature at an intersection of the straight line and the tangent line was determined as the glass transition temperature (Tg).

[Softening Temperature (Tm)]

Using a device for evaluating flow characteristics: Flow tester CFT-100C (trade name) manufactured by Shimadzu Corporation, 1 g of a sample (which is fine resin particles) was heated at a temperature of which increase rate was 6° C./min, under load of 10 kgf/cm² (9.8×10⁵ Pa) so as to be pushed out of a die (which is a nozzle having an aperture of 1 mm and a length of 1 mm), and a temperature of the sample at the time when a half of the sample had flowed out of the die was determined as the softening temperature (Tm).

[Melting Temperature]

Using the differential scanning calorimeter: DSC220 (trade name) manufactured by Seiko Electronics Inc., 1 g of a sample was heated from a temperature of 20° C. up to 150° C. at a temperature of which increase rate was 10° C./min, and then an operation of rapidly cooling down the sample from 150° C. to 20° C. was repeated twice, thus obtaining a DSC curve. A temperature obtained at a top of an endothermic peak which corresponds to the melting shown on the DSC curve obtained at the second operation, was determined as the melting temperature.

[Volume Average Particle Size D_{L} (Laser diffractometry)]

A laser diffraction/scattering particle size analyzer: LA-920 (trade name) manufactured by HORIBA, Ltd., was used for batch-cell measurement. A sample used for measurement of volume average particle size R_{C} (Coulter method) was prepared and put in a batch cell. While the sample was sufficiently agitated by a magnetic stirrer, the measurement was conducted. In the measurement, the data was read 15 times with a refractive index of 1.16-0.00 i (HeNe) and 1.19-0.00 i (W). A volume average particle size D_{L} (unit: μm) of fine resin particles was thus obtained.

[Volume Average Particle Size D_{C} (Coulter Method)]

To 50 ml of electrolyte: ISOTON II (trade name) manufactured by Beckman Coulter, Inc. were added 20 mg of a sample and 1 ml of alkyl ether sulfuric ester sodium (which is a dispersant manufactured by Kishida Chemical Co., Ltd.), which were then subjected to a three-minute dispersion treatment of an ultrasonic distributor: UH-50 (trade name) manufactured by STM Co., Ltd. at ultrasonic frequency of 20 kHz, thereby preparing a measurement sample. The measurement sample was analyzed by a particle size distribution-measuring device: MULTISIZER III (trade name) manufactured by Beckman Coulter, Inc. under the conditions that an aperture diameter was 30 μm and the number of particles for measurement was 50,000 counts. On the basis of the measurement result thus obtained, a particle size D_{C} in accumulated volume distribution positioned at 50% in an accumulated volume counted from a larger particle size was determined as a volume average particle size (μm) of a toner. Further, a standard deviation (μm) in the volume particle size distribution was obtained, and a coefficient of variation (abbreviated as “CV value” represented in percentage) was determined based on the following expression (3). A smaller coefficient of variation represents a narrower width of the particle size distribution.

CV value(%)=(Standard deviation(μm)in the volume particle size distribution/Volume average particle size(μm))×100 (3)

[Number Average Particle Size]

From the external additive, 100 particles were randomly extracted and observed at 20,000-fold magnification by a transmission electron microscope. An image thus obtained was analyzed to determine particle sizes of primary particles. A number average particle size was determined from the particle sizes thus determined.

[Measurement of Fourier Coefficient]

A toner particle was photographed at 8,000-fold magnification by an electron microscope: VE-9500 (trade name) manufactured by Keyence Corporation (FIG. 8). Subsequently, in the photograph of the toner particle thus obtained, an outline of the toner particle is defined and analyzed by image analysis software: A-ZO KUN (trade name) manufactured by Asahi Kasei Engineering Corporation. A center of gravity (coordinate) of the outline was thus obtained (FIG. 9). In the meantime, a 360-degree radiation view equally divided from its center into 128 parts was prepared (FIG. 10). On the center of the radiation view, the center of gravity of the outline was superimposed (FIG. 11). For each of 128 radiations, a length from the center of gravity to the outline was measured by A-ZO KUN. Of these measured lengths (of 128 radiations in total) from the center of gravity to the outline, the longest one was defined as a starting point (zero degree), and lengths for respective angles were sequentially plotted. Using an analyzing tool of spreadsheet software: Excel (trade name) manufactured by Microsoft Corporation, Fourier analysis was performed to determine cosine Fourier coefficients a₁ to a₆₄ from a real part of the above expression (2) and determine sine Fourier coefficients b₁ to b₆₄ from an imaginary part of the following expression (2).

Fourier coefficients of 100 toner particles randomly extracted were determined. As a result, a₂/a₀ and a₃/a₀ became distinctive values depending on shape differences.

[Preparation of Water]

In the following Examples and Comparative examples, water having electric conductivity of 0.5 μS/cm was used for aqueous mediums and for washing. An ultra pure water manufacturing device: MINIPURE TW-300RU (trade name) manufactured by Nomura Micro Science Co., Ltd. was used to prepare the washing water from tap water. The electric conductivity of the water was measured by Lacom tester EC-PHCON10 (trade name) manufactured by AS ONE Corporation.

### EXAMPLE 1

### Fine Particle Preparing Step

A toner composition was prepared which contains: 87.5% by weight of polyester resin (having a glass transition temperature (Tg) of 60° C. and a softening temperature (Tm) of 110° C.), serving as binder resin; 8% by weight of phthalocyanine blue: copper phthalocyanine 15:3 (trade name) manufactured by Clariant Corporation, serving as colorant; 3% by weight of polyester wax (having a melting temperature of 85° C.), serving as a release agent; and 1.5% by weight of a charge control agent: TRH (trade name) manufactured by Hodogaya Chemical Co., Ltd. The toner composition was mixed by a mixer: HENSCHELMIXER (trade name) manufactured by Mitsui Mining Co., Ltd. An admixture thus obtained was molten and kneaded by a twin-screw extruder: PCM-30 (trade name) manufactured by Ikegai Ltd. with cylinder temperature of 145° C. and a barrel rotational speed of 300 rpm. Molten and kneaded materials of the toner composition were thus prepared. The molten and kneaded materials were cooled down to room temperature and then coarsely pulverized by a cutter mill: VM-16 (trade name) manufactured by Seishin Enterprise Co., Ltd., thereby preparing molten and kneaded materials having a volume average particle sizes of 200 μm. The molten and kneaded materials had a softening temperature (Tm) of 110° C.

An admixture was then obtained by mixing: 30 g (5% by weight) of the above molten and kneaded materials; 3 g (0.5% by weight) of sodium polyacrylate: D-H14-N L-7403KN (trade name) manufactured by Nippon Nyukazai Co., Ltd., serving as anionic surfactant; and 567 g (94.5% by weight) of water (having a temperature of 20° C. and electric conductivity of 0.5 μS/cm). The admixture was then put in a tank of a high-pressure homogenizer: NANO3000 (trade name) manufactured by Beryu Co., Ltd. and coarsely pulverized in the high-pressure homogenizer method under conditions of 25° C. and 100 MPa. Coarse particle slurry was thus prepared.

Next, the coarse particle surly thus obtained was put in the tank of the high-pressure homogenizer: NANO3000 (trade name) manufactured by Beryu Co., Ltd. again and formed into fine particles in the high-pressure homogenizer method under conditions of 120° C. and 160 MPa, thereby fabricating fine resin particle slurry. The fine resin particles thus obtained had a volume average particle size (D_{L}) of 0.9 μm (of which coefficient of variation (CV value) was 25(%)).

[Aggregating Step]

To 100 parts by weight of the fine resin particle slurry obtained in the fine particle preparing step, 2 parts by weight of sodium chloride: special-grade sodium chloride (trade name) manufactured by Kishida Chemical Co., Ltd. was added as an aggregating agent. The slurry was then agitated for ten minutes by an emulsifier of single motion type: CLEARMIX (trade name) manufactured by M Technique Co., Ltd. at aggregating temperature of 85° C. and rotor rotational speed of 8,000 rpm. Coarse particle slurry was thus prepared having aggregated fine resin particles.

[Washing Step]

To the particle-aggregated slurry obtained in the aggregating step, water (having a temperature of 20° C. and electric conductivity of 0.5 μS/cm) was added so that a solid content became 10% by weight. The water-added particle-aggregated slurry was then agitated for 30 minutes by a turbine agitating blade: H-701FR (trade name) manufactured by Kokusan Co., Ltd. at rotational speed of 300 rpm. This operation was repeated until electric conductivity of the supernatant solution separated from the agitated admixture by centrifugation became 10 μS/cm or less. The aggregated particles contained in the particle-aggregated slurry were washed.

[Separating Step]

From the admixture of aggregated particle-containing aqueous medium after the washing step, a solid content containing aggregated particles was taken out through centrifugation in a centrifuge: H-122 (trade name) manufactured by Kokusan Co., Ltd.

[Drying Step]

The solid content taken out in the separating step was freeze-dried into toner particles (aggregated particles). The toner particles (aggregated particles) had a volume average particle size (D_{C}) of 5.9 μm, and Fourier coefficients a₂/a₀ of 0.15 and a₀⁻¹(a₂²+b₂²)^{1/2} of 0.15.

To 100 parts by weight of the toner particles (aggregated particles) thus obtained, there were externally added: 2 parts by weight of silica of which primary particles had a number average particle size of 12 nm, manufactured by Nippon Aerosil Co., Ltd.; and 0.6 part by weight of silica of which primary particles had a number average particle size of 80 nm, manufactured by Tayca Corporation. A toner was thus manufactured.

### EXAMPLE 2

A toner was manufactured in the same manner as Example 1 except that the aggregating temperature in the aggregating step was set at 80° C. Toner particles (aggregated particles) obtained after the drying step had a volume average particle size of 5.6 μm, and Fourier coefficients a₂/a₀ of 0.24 and a₀⁻¹(a₂²+b₂²)^{1/2} of 0.24.

### EXAMPLE 3

A toner was manufactured in the same manner as Example 1 except that the aggregating temperature in the aggregating step was set at 75° C. Toner particles (aggregated particles) obtained after the drying step had a volume average particle size of 5.3 μm, and Fourier coefficients a₂/a₀ of 0.35 and a₀⁻¹(a₂²+b₂²)^{1/2} of 0.35.

### EXAMPLE 4

A toner was manufactured in the same manner as Example 1 except that the amount of the aggregating agent added in the aggregating step was set at 3 parts by weight. Toner particles (aggregated particles) obtained after the drying step had a volume average particle size of 6.1 μm, and Fourier coefficients a₃/a₀ of 0.08 and a₀⁻¹(a₃²+b₃²)^{1/2} of 0.08.

### EXAMPLE 5

A toner was manufactured in the same manner as Example 1 except that the amount of the aggregating agent added in the aggregating step was set at 3 parts by weight and that the aggregating temperature in the aggregating step was set at 80° C. Toner particles (aggregated particles) obtained after the drying step had a volume average particle size of 5.8 μm, and Fourier coefficients a₃/a₀ of 0.11 and a₀⁻¹(a₃²+b₃²)^{1/2} of 0.11.

### EXAMPLE 6

A toner was manufactured in the same manner as Example 1 except that the amount of the aggregating agent added in the aggregating step was set at 3 parts by weight and that, the aggregating temperature in the aggregating step was set at 75° C. Toner particles (aggregated particles) obtained after the drying step had a volume average particle size of 5.5 μm, and Fourier coefficients a₃/a₀ of 0.20 and a₀⁻¹(a₃²+b₃²)^{1/2} of 0.20.

### EXAMPLE 7

### Fine Particle Preparing Step

Preparation of Resin Particle Dispersion

Into aqueous solution of one liter ion-exchange water where 1.2% by weight of NONIPOL 400 manufactured by Sanyo Chemical Indusries, Ltd. and 2% by weight of sodium dodecylbenzene sulfonate manufactured by Kishida Chemical Co., Ltd. were dispersed as surfactant, 840 g of an admixture was emulsified. The admixture contained 80% by weight of styrene, 15% by weight of n-butyl acrylate, 2% by weight of acrylic acid, 2% by weight of dodecanthiol, and 1% by weight of carbon tetrabromide. After the emulsification, 100 ml of ion-exchange water containing ammonium persulfate of 7.5% by weight was put, followed by nitrogen substitution and agitation while heating until a temperature of the content became 70° C. This operation lasted seven hours. The fine resin particles thus obtained had a volume average particle size (D_{L}) of 0.2 μm (of which coefficient of variation (CV value) was 25(%)).

Preparation of Colorant Dispersion

With one liter ion-exchange water, there were mixed: 2.5% by weight of sodium dodecylbenzene sulfonate manufactured by Kishida Chemical Co., Ltd., serving as surfactant; and 25% by weight of phthalocyanine blue: copper phthalocyanine 15:3 (trade name) manufactured by Clariant Corporation, serving as colorant. An admixture thus obtained was then treated with a dispersion process by using NANO3000 manufactured by Beryu, Co., Ltd. The fine colorant particles thus obtained had a volume average particle size (D_{L}) of 0.15 μm (of which coefficient of variation (CV value) was 24(%)).

Preparation of Release Agent Dispersion

With one liter ion-exchange Water, there were mixed: 2.5% by weight of SANISOL B-50 manufactured by Kao Corporation, serving as surfactant; and HNP10 manufactured by Nihon Seiro Co., Ltd., serving as a release agent. An admixture thus obtained was heated up to 95° C. and treated with a dispersion process by using T.K. HOMOMIXER MARK II (trade name) manufactured by PRIMIX Corporation. The fine release agent-particles thus obtained had a volume average particle size (D_{L}) of 0.2 μm (of which coefficient of variation (CV value) was 25(%)).

Preparation of Mixed Fine Particle Dispersion

With one liter ion-exchange water, there were mixed: 0.25% by weight of SANISOL B-50 manufactured by Kao Corporation and 0.8% by weight of sodium dodecylbenzene sulfonate manufactured by Kishida Chemical Co., Ltd., serving as surfactant; 33% by weight of the resin particle dispersion; 5% by weight of the colorant dispersion; and 7% by weight of the release agent dispersion.

A toner was manufactured in the same manner as Example 1 except that the amount of the aggregating agent added to the mixed fine particle dispersion was set at 3 parts by weight and that the aggregating temperature was set at 90° C. Toner particles (aggregated particles) obtained after the drying step had a volume average particle size of 5.1 μm and Fourier coefficient a₀⁻¹(a₃²+b₃²)^{1/2} of 0.10.

### EXAMPLE 8

A toner was manufactured in the same manner as Example 1 except that the aggregating temperature in the aggregating step was set at 88° C. and that the rotor rotational speed in the aggregating step was set at 14,000 rpm. Toner particles (aggregated particles) obtained after the drying step had a volume average particle size of 5.0 μm and Fourier coefficient a₀⁻¹(a₂²+b₃²)^{1/2} of 0.12.

### EXAMPLE 9

A toner was manufactured in the same manner as Example 1 except that the aggregating temperature in the aggregating step was set at 88° C. and that the rotor rotational speed in the aggregating step was set at 13,000 rpm. Toner particles (aggregated particles) obtained after the drying step had a volume average particle size of 5.2 μm and Fourier coefficient a₀⁻¹(a₂²+b₃²)^{1/2} of 0.21.

### EXAMPLE 10

A toner was manufactured in the same manner as Example 1 except that the aggregating temperature in the aggregating step was set at 88° C. and that the rotor rotational speed in the aggregating step was set at 12,000 rpm. Toner particles (aggregated particles) obtained after the drying step had a volume average particle size of 5.5 μm and Fourier coefficient, a₀⁻¹(a₂²+b₃²)^{1/2} of 0.35.

### EXAMPLE 11

A toner was manufactured in the same manner as Example 1 except that the aggregating temperature in the aggregating step was set at 85° C. and that the rotor rotational speed in the aggregating step was set at 13,000 rpm. Toner particles (aggregated particles) obtained after the drying step had a volume average particle size of 4.7 μm and Fourier coefficient a₀¹ (a₂²+a₃²)^{1/2} of 0.10.

### EXAMPLE 12

A toner was manufactured in the same manner as Example 1 except that the aggregating temperature in the aggregating step was set at 85° C. and that the rotor rotational speed in the aggregating step was set at 12,000 rpm. Toner particles (aggregated particles) obtained after the drying step had a volume average particle size of 5.1 μm and Fourier coefficient a₀¹ (a₂²+a₃²)^{1/2} of 0.19.

### EXAMPLE 13

A toner was manufactured in the same manner as Example 1 except that the aggregating temperature in the aggregating step was set at 85° C. and that the rotor rotational speed in the aggregating step was set at 11,000 rpm. Toner particles (aggregated particles) obtained after the drying step had a volume average particle size of 5.2 μm and Fourier coefficient a₀⁻¹(a₂²+a₃²)^{1/2} of 0.35.

### EXAMPLE 14

A toner was manufactured in the same manner as Example 1 except that the aggregating temperature in the aggregating step was set at 83° C. and that the rotor rotational speed in the aggregating step was set at 13,000 rpm. Toner particles (aggregated particles) obtained after the drying step had a volume average particle size of 4.7 μm and Fourier coefficient a₀⁻¹(a₂²+b₄²)^{1/2} of 0.09.

### EXAMPLE 15

A toner was manufactured in the same manner as Example 1 except that the aggregating temperature in the aggregating step was set at 83° C. and that the rotor rotational speed in the aggregating step was set at 12,000 rpm. Toner particles (aggregated particles) obtained after the drying step had a volume average particle size of 5.0 μm and Fourier coefficient a₀⁻¹(a₂²+b₄²)^{1/2} of 0.23.

### EXAMPLE 16

A toner was manufactured in the same manner as Example 1 except that the aggregating temperature in the aggregating step was set at 83° C. and that the rotor rotational speed in the aggregating step was set at 10,000 rpm. Toner particles (aggregated particles) obtained after the drying step had a volume average particle size of 5.1 μm and Fourier coefficient a₀⁻¹(a₂²+b₄²)^{1/2} of 0.33.

### EXAMPLE 17

A toner was manufactured in the same manner as Example 1 except that the rotor rotational speed in the aggregating step was set at 9,000 rpm. Toner particles (aggregated particles) obtained after the drying step had a volume average particle size of 5.6 μm and Fourier coefficient a₂/a₀ of 0.11.

### EXAMPLE 18

A toner was manufactured in the same manner as Example 1 except that the aggregating temperature in the aggregating step was set at 80° C. and the rotor rotational speed in the aggregating step was set at 7,000 rpm. Toner particles (aggregated particles) obtained after the drying step had a volume average particle size of 5.8 μm and Fourier coefficient a₂/a₀ of 0.39.

### EXAMPLE 19

A toner was manufactured in the same manner as Example 1 except that the amount of the aggregating agent added in the aggregating step was set at 3 parts by weight and that the rotor rotational speed in the aggregating step was set at 9,000 rpm. Toner particles (aggregated particles) obtained after the drying step had a volume average particle size of 5.8 μm and Fourier coefficient a₃/a₀ of 0.06.

### EXAMPLE 20

A toner was manufactured in the same manner as Example 1 except that the amount of the aggregating agent added in the aggregating step was set at 3 parts by weight; that the aggregating temperature in the aggregating step was set at 80° C.; and that the rotor rotational speed in the aggregating step was set at 7,000 rpm. Toner particles (aggregated particles) obtained after the drying step had a volume average particle size of 6.0 μm and Fourier coefficient a₃/a₀ of 0.22.

### EXAMPLE 21

A toner was manufactured in the same manner as Example 1 except that the volume average particle size of the fine resin particles obtained in the fine resin particle preparing step was 0.12 μm (of which coefficient of variation (CV value) was 27(%)) and that the aggregating temperature in the aggregating step was 80° C. Toner particles (aggregated particles) obtained after the drying step had a volume average particle size of 2.8 μm and Fourier coefficient a₃/a₀ of 0.05.

### EXAMPLE 22

A toner was manufactured in the same manner as Example 1 except that the volume average particle size of the fine resin particles obtained in the fine resin particle preparing step was 3.5 μm (of which coefficient of variation (CV value) was 37(%)) and that the aggregating temperature in the aggregating step was 80° C. Toner particles (aggregated particles) obtained after the drying step had a volume average particle size of 12 μm (of which coefficient of variation (CV value) was 49(%)), thus failing to obtain a toner formed of uniformly shaped particles.

### EXAMPLE 23

In the fine particle preparing step, not the high-pressure homogenizer method but the dissolution suspension method was used to prepare the fine resin particles. Specifically, to solution of sodium polyacrylate was added a resin solution admixture where the kneaded materials of the toner composition were dissolved and dispersed in methyl ethyl ketone. An admixture thus obtained was then put in a rotor/stator agitator: T.K. HOMOMIXER MARK II (trade name) manufactured by PRIMIX Corporation, and thereby agitated for 20 minutes at temperature of 20° C. and agitator rotational speed of 5,000 rpm, followed by removal of methyl ethyl ketone. Fine resin particles were thus obtained.

The fine resin particles thus obtained had a volume average particle size (D_{L}) of 2.4 μm (of which coefficient of variation (CV value) was 48(%)). A toner was manufactured in the same manner as Example 1 except that the dissolution suspension method was used to prepare the fine resin particles. Toner particles (aggregated particles) obtained after the drying step had a volume average particle size of 9 μm (of which coefficient of variation (CV value) was 45(%)), thus failing to obtain a toner formed of uniformly shaped particles.

### EXAMPLE 24

A toner was manufactured in the same manner as Example 1 except that the aggregating temperature in the aggregating step was set at 88° C. and that the rotor rotational speed in the aggregating step was set at 15,000 rpm. Toner particles (aggregated particles) obtained after the drying step had a volume average particle size of 4.5 μm and Fourier coefficient a₀⁻¹(a₂²+b₂²) 1/2 of 0.08.

### EXAMPLE 25

A toner was manufactured in the same manner as Example 1 except that the aggregating temperature in the aggregating step was set at 88° C. and that the rotor rotational speed in the aggregating step was set at 8,000 rpm. Toner particles (aggregated particles) obtained after the drying step had a volume average particle size of 5.7 μm and Fourier coefficient a₀⁻¹(a₂²+b₂²)^{1/2} of 0.39.

### EXAMPLE 26

A toner was manufactured in the same manner as Example 1 except that the aggregating temperature in the aggregating step was set at 85° C. and that the rotor rotational speed in the aggregating step was set at 15,000 rpm. Toner particles (aggregated particles) obtained after the drying step had a volume average particle size of 4.6 μm and Fourier coefficient a₀⁻¹(a₂²+a₃²)^{1/2} of 0.09.

### EXAMPLE 27

A toner was manufactured in the same manner as Example 1 except that the aggregating temperature in the aggregating step was set at 85° C. and that the rotor rotational speed in the aggregating step was set at 8,000 rpm. Toner particles (aggregated particles) obtained after the drying step had a volume average particle size of 5.8 μm and Fourier coefficient a₀⁻¹(a₂²+a₃²)^{1/2} of 0.40.

### EXAMPLE 28

A toner was manufactured in the same manner as Example 1 except that the aggregating temperature in the aggregating step was set at 83° C. and that the rotor rotational speed in the aggregating step was set at 15,000 rpm. Toner particles (aggregated particles) obtained after the drying step had a volume average particle size of 4.5 μm and Fourier coefficient a₀⁻¹(a₂²+b₄²)^{1/2} of 0.06.

### EXAMPLE 29

A toner was manufactured in the same manner as Example 1 except that the aggregating temperature in the aggregating step was set at 83° C. and that the rotor rotational speed in the aggregating step was set at 8,000 rpm. Toner particles (aggregated particles) obtained after the drying step had a volume average particle size of 5.7 μm and Fourier coefficient a₀⁻¹(a₂²+b₄²)^{1/2} of 0.39.

### EXAMPLE 30

A toner was manufactured in the same manner as Example 1 except that the fine resin particles obtained in the fine resin particle step were used in the aggregating step. Toner particles (aggregated particles) obtained after the drying step had a volume average particle size of 5.4 μm and satisfied (S₂/S₁)+(S₃/S₁)=0.33.

### COMPARATIVE EXAMPLE 1

To 170 parts by weight of polyester resin (having a glass transition temperature (Tg) of 60° C. and a softening temperature (Tm) of 110° C.) as main resin, 180 parts by weight of methyl ethyl ketone was added. After methyl ethyl ketone was sufficiently dissolved in the polyester resin, there was added 20 parts by weight of phthalocyanine blue: copper phthalocyanine 15:3 (trade name) manufactured by Clariant Corporation, serving as colorant. An admixture thus obtained was then put in FILMICS MODEL 56 (trade name) manufactured by PRIMIX Corporation, and dispersed for five minutes at 40 m/s. After the dispersion, the admixture was adjusted with methyl ethyl ketone so that a solid content became 50%. A resin solution (A) was thus obtained.

Next, a resin solution (B) was obtained in the manner as that of the resin solution (A) except that 10 parts by weight of carnauba wax (having a melting temperature of 83° C.) was added instead of 20 parts by weight of phthalocyanine blue as a release agent and that the dispersion of FILMICS MODEL 56 was conducted for three minutes at 30 m/s.

To 300 parts by weight of a resin solution admixture containing 100 parts by weight of the resin solution (A) and 100 parts by weight of the resin solution (B), 3 parts by weight of 1N ammonia water was added. The rotational speed of the homogenizer was then set at 5,000 rpm to carry out phase-inversion emulsification with dropping of 180 parts by weight of deionized water. Subsequently, 35 parts by weight of cation-exchange resin was mixed with water dispersion of colorant-encapsulated particles having methyl ethyl ketone removed therefrom through distillation under reduced pressure, and agitated for two hours at 30° C. and 50 rpm, thereafter being washed with water, filtered, and dried. A toner was thus obtained having a volume average particle size of 5.6 μm and a coefficient of variation (CV) of 28. To 100 parts by weight of the toner particles thus obtained, there were externally added: 2 parts by weight of silica of which primary particles had a number average particle size of 12 nm, manufactured by Nippon Aerosil Co., Ltd.; and 0.6 part by weight of silica of which primary particles had a number average particle size of 80 nm, manufactured by Tayca Corporation. A toner of Comparative example 1 was thus manufactured.

### COMPARATIVE EXAMPLE 2

A toner composition was prepared which contains: 87.5% by weight of polyester resin (having a glass transition temperature (Tg) of 60° C. and a softening temperature (Tm) of 110° C.), as main resin; 8% by weight of phthalocyanine blue: copper phthalocyanine 15:3 (trade name) manufactured by Clariant Corporation, serving as colorant; 5% by weight of paraffin wax (having a melting temperature of 83° C.), serving as a release agent; and 1.5% by weight of a charge control agent: TRH (trade name) manufactured by Hodogaya Chemical Co., Ltd. The toner composition was mixed by a mixer: HENSCHELMIXER (trade name) manufactured by Mitsui Mining Co., Ltd. An admixture thus obtained was molten and kneaded by a twin-screw extruder: PCM-30 (trade name) manufactured by Ikegai Ltd. with cylinder temperature of 145° C. and a barrel rotational speed of 300 rpm. Molten and kneaded materials of the toner composition were thus prepared. The molten and kneaded materials were cooled down to room temperature and then coarsely pulverized by a cutter mill: VM-16 (trade name) manufactured by Seishin Enterprise Co., Ltd. And then an excessively pulverized toner was removed by classification in a rotary classifier. A toner was thus obtained having a volume average particle size of 6.7 μm and a coefficient of variation (CV) of 24. To 100 parts by weight of the toner particles (pulverized particles) thus obtained, there were externally added: 2 parts by weight of silica of which primary particles had a number average particle size of 12 nm, manufactured by Nippon Aerosil Co., Ltd.; and 0.6 part by weight of silica of which primary particles had a number average particle size of 80 nm, manufactured by Tayca Corporation. A toner of Comparative example 2 was thus manufactured.

The following table 1 collectively shows the conditions (of the amount of added aggregating agent, the aggregating temperature, and the rotational speed of the rotor) in the steps of manufacturing the toners of Examples 1 to 30 and Comparative examples 1 and 2, and the property vales (of the volume average particle sizes (D_{L}, D_{C}) and Fourier coefficient) of the fine resin particles and toner particles (aggregated particles).

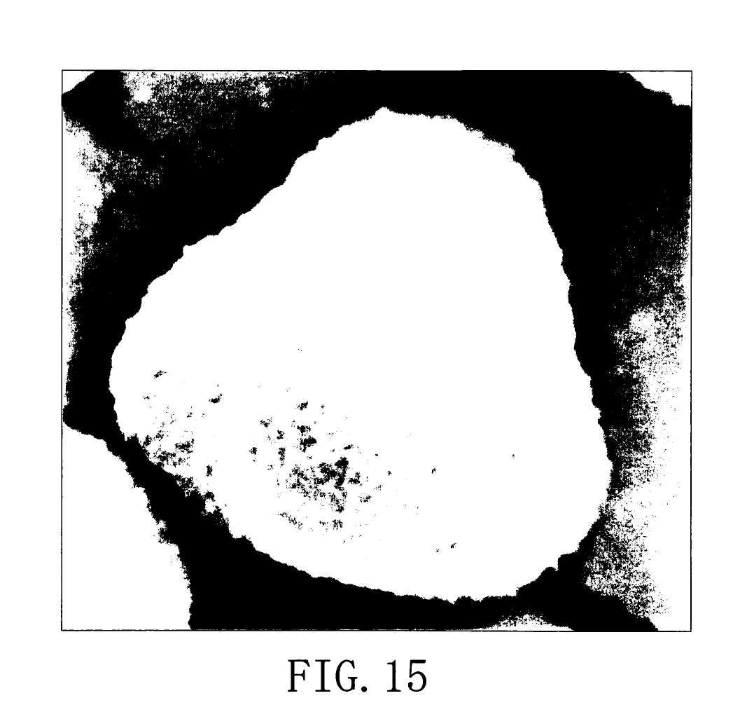

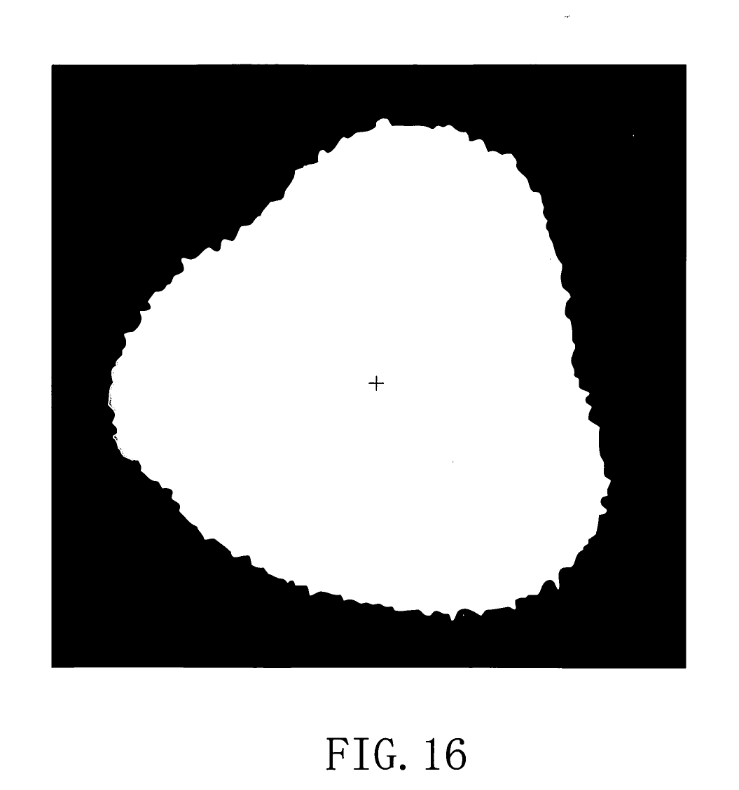

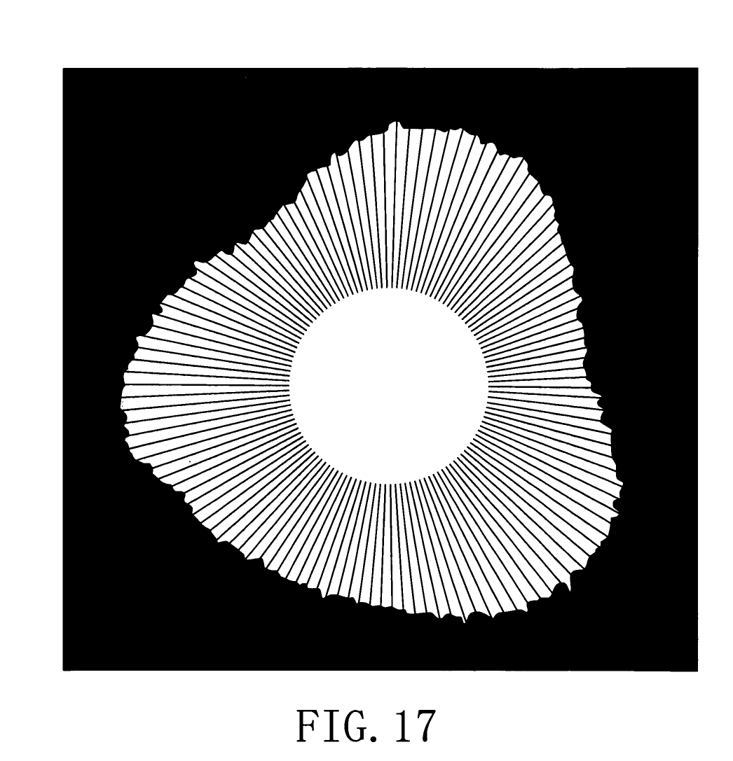

FIG. 15 is a view showing an SEM photograph image of the toner particles of Example 5. FIG. 16 is a projection view obtained by defining an outline of the photograph image of FIG. 15. FIG. 17 is a view obtained by overlapping a coordinate of the center of gravity of the outline of the projection view of FIG. 16 with the center of the radiation view of FIG. 10.

TABLE 1

| | Volume | | | | | | | |
|---|---|---|---|---|---|---|---|---|
| | average | Amount of | | | | | | |
| | particle size D_{L} | added | | | Volume average | | | |
| | of fine resin | aggregating | Rotor | Aggregating | particle size | | | |
| | particles | agent | rotational | temp. | D_{C} of toner | Fourier coefficient | | |
| | (μm) | (wt %) | speed (rpm) | (° C.) | (μm) | (S₂/S₁) + (S₃/S₁) | a₀⁻¹(a₂² + b₂²)^{1/2} | a₀⁻¹(a₃² + b₃²)^{1/2} |
| Ex. 1 | 0.9 | 2 | 8000 | 85 | 5.9 | 1 | 0.15 | — |
| Ex. 2 | 0.9 | 2 | 8000 | 80 | 5.6 | 1 | 0.24 | — |
| Ex. 3 | 0.9 | 2 | 8000 | 75 | 5.3 | 1 | 0.35 | — |
| Ex. 4 | 0.9 | 3 | 8000 | 85 | 6.1 | 2 | — | 0.08 |
| Ex. 5 | 0.9 | 3 | 8000 | 80 | 5.8 | 2 | — | 0.11 |
| Ex. 6 | 0.9 | 3 | 8000 | 75 | 5.5 | 2 | — | 0.20 |
| Ex. 7 | 0.2 | 3 | 8000 | 90 | 5.1 | 2 | — | 0.10 |
| Ex. 8 | 0.9 | 2 | 14000 | 88 | 5.0 | 1 | — | — |
| Ex. 9 | 0.9 | 2 | 13000 | 88 | 5.2 | 1 | — | — |
| Ex. 10 | 0.9 | 2 | 12000 | 88 | 5.5 | 1 | — | — |
| Ex. 11 | 0.9 | 2 | 13000 | 85 | 4.7 | 0.41 | — | — |
| Ex. 12 | 0.9 | 2 | 12000 | 85 | 5.1 | 0.61 | — | — |
| Ex. 13 | 0.9 | 2 | 11000 | 85 | 5.2 | 0.93 | — | — |
| Ex. 14 | 0.9 | 2 | 13000 | 83 | 4.7 | 1 | — | — |
| Ex. 15 | 0.9 | 2 | 12000 | 83 | 5.0 | 1 | — | — |
| Ex. 16 | 0.9 | 2 | 10000 | 83 | 5.1 | 1 | — | — |
| Ex. 17 | 0.9 | 2 | 9000 | 85 | 5.6 | 1 | 0.11 | — |
| Ex. 18 | 0.9 | 2 | 7000 | 80 | 5.8 | 1 | 0.39 | — |
| Ex. 19 | 0.9 | 3 | 9000 | 85 | 5.8 | 2 | — | 0.06 |
| Ex. 20 | 0.9 | 3 | 7000 | 80 | 6.0 | 2 | — | 0.22 |
| Ex. 21 | 0.12 | 2 | 8000 | 80 | 2.8 | 2 | — | 0.05 |
| Ex. 22 | 3.5 | 2 | 8000 | 80 | 12.0 | — | — | — |
| Ex. 23 | 2.4 | 2 | 8000 | 80 | 9.0 | — | — | — |
| Ex. 24 | 0.9 | 2 | 15000 | 88 | 4.5 | 1 | — | — |
| Ex. 25 | 0.9 | 2 | 8000 | 88 | 5.7 | 1 | — | — |
| Ex. 26 | 0.9 | 2 | 15000 | 85 | 4.6 | 0.37 | — | — |
| Ex. 27 | 0.9 | 2 | 8000 | 85 | 5.8 | 0.97 | — | — |
| Ex. 28 | 0.9 | 2 | 15000 | 83 | 4.5 | 1 | — | — |
| Ex. 29 | 0.9 | 2 | 8000 | 83 | 5.7 | 1 | — | — |
| Ex. 30 | 3.5/0.9 | 2 | 8000 | 85 | 5.4 | 0.33 | — | — |
| Com. Ex. 1 | — | — | — | — | 5.6 | — | — | — |
| Com. Ex. 2 | — | — | — | — | 6.7 | — | — | — |

Evaluation items

| | | | Charge |
|---|---|---|---|
| Fourier coefficient | Cleaning | Transfer | amount |

| | a₀⁻¹(a₂² + b₃²)^{1/2} | a₀⁻¹(a₂² + a₃²)^{1/2} | a₀⁻¹(a₂² + b₄²)^{1/2} | property | efficiency | distribution |
|---|---|---|---|---|---|---|
| Ex. 1 | — | — | — | Good | Very good | Very good |
| Ex. 2 | — | — | — | Very good | Very good | Very good |
| Ex. 3 | — | — | — | Very good | Very good | Good |
| Ex. 4 | — | — | — | Good | Very good | Very good |
| Ex. 5 | — | — | — | Very good | Very good | Very good |
| Ex. 6 | — | — | — | Very good | Very good | Good |
| Ex. 7 | — | — | — | Good | Very good | Very good |
| Ex. 8 | 0.12 | — | — | Good | Very good | Very good |
| Ex. 9 | 0.21 | — | — | Good | Very good | Very good |
| Ex. 10 | 0.35 | — | — | Very good | Very good | Very good |
| Ex. 11 | — | 0.10 | — | Good | Very good | Very good |
| Ex. 12 | — | 0.19 | — | Very good | Very good | Very good |
| Ex. 13 | — | 0.35 | — | Very good | Very good | Very good |
| Ex. 14 | — | — | 0.09 | Good | Very good | Very good |
| Ex. 15 | — | — | 0.23 | Very good | Very good | Very good |
| Ex. 16 | — | — | 0.33 | Very good | Very good | Very good |
| Ex. 17 | — | — | — | Not bad | Very good | Very good |
| Ex. 18 | — | — | — | Very good | Not bad | Not bad |
| Ex. 19 | — | — | — | Not bad | Very good | Very good |
| Ex. 20 | — | — | — | Very good | Not bad | Not bad |
| Ex. 21 | — | — | — | Not bad | Very good | Very good |
| Ex. 22 | — | — | — | Very good | Not bad | Not bad |
| Ex. 23 | — | — | — | Very good | Not bad | Not bad |
| Ex. 24 | 0.08 | — | — | Not bad | Very good | Very good |
| Ex. 25 | 0.39 | — | — | Very good | Not bad | Not bad |
| Ex. 26 | — | 0.09 | — | Not bad | Very good | Very good |
| Ex. 27 | — | 0.40 | — | Very good | Not bad | Not bad |
| Ex. 28 | — | — | 0.06 | Not bad | Very good | Very good |
| Ex. 29 | — | — | 0.39 | Very good | Not bad | Not bad |
| Ex. 30 | — | — | — | Good | Not bad | Not bad |
| Com. Ex. 1 | — | — | — | Poor | Good | Good |
| Com. Ex. 2 | — | — | — | Good | Poor | Poor |

[Evaluation]

Using the toners manufactured according to the above methods of Examples 1 to 16 and Comparative examples 1 to 13, documents were printed by a copier: MX-4500FN (trade name) manufactured by Sharp Corporation to thereby evaluate a cleaning property, transferring efficiency, and a charge amount distribution as follows. Table 1 shows results of the evaluations. Note that in the evaluation result of Table 1, “Good” indicates that the toner is excellent; “Not bad” indicates that the toner is practicable; and “Poor” indicates that the toner is hard to be practically used.

[Cleaning Property]

After 20,000 sheets of 5% coverage rate documents were continuously printed, a surface of a photoreceptor was checked with eyes to determine whether or not the toner filming occurred thereon. A cleaning property was evaluated based on the following criteria.

Very good: no toner filming occurred.

Good: toner filming occurred after continuously printing 20,000 sheets.

Not bad: toner filming occurred after continuously printing 10,000 sheets.

Poor: toner filming occurred after continuously printing 5,000 sheets.

[Transfer Efficiency]

Approximate transfer efficiency was determined by the following expression and used for ranking as follows. In the expression, C represents a value of Macbeth density of a Mylar tape stuck onto a sheet, which Mylar tape was peeled off from a surface of a photoreceptor on which a toner remains after a solid black image was transferred onto an A4-sized blank sheet; E represents Macbeth density of a Mylar tape stuck onto a sheet having a toner already transferred but not yet fixed; and D represents Macbeth density of a Mylar tape stuck onto an unused sheet. A Macbeth reflection densitometer: RD-914 manufactured by Macbeth Co. was used for the measurement.

Transfer efficiency (%)=(E-C)×100/(E−D)

Very good: the transfer efficiency exceeding 90%

Good: the transfer efficiency of 90% or less and 80% or more

Not bad: the transfer efficiency of 80% or less and 70% or more

Poor: the transfer efficiency of 70% or less

[Charge Amount Distribution]

Using a particle charge distribution analyzer: E-SPART Analyzer model EST-1 manufactured by Hosokawa Micron Corporation, the particle size and the particle charge amount were simultaneously determined based on measurement according to the laser Doppler method of transfer rate of particles within a vibration range of sound wave in the direct electric field. Start developer was put in a feeder for measurement, and from an upper part of the analyzer with a table rotated by magnet voltage, a toner soared with the aid of N₂ gas and was caught into the analyzer. The measurement was conducted until 3,000 counts under a set condition of: pulse duration of 3 to 5; an interval of 4 to 6 seconds; a rotation speed of 150 to 250/1500 rpm; and an amount of N₂ gas of 0.3 kg/cm²G to 0.4 kg/cm²G. Arithmetic calculation was then conducted for the measurement by counting cathode and anode for each particle size d (μm) of channels, thereby forming a coordinate with an abscissa of Q/d and an ordinate of N (a.u.) quantity. In the coordinate, a standard deviation was determined and used for ranking as follows.

Very good: the standard deviation less than 0.05 (μm)

Good: the standard deviation between 0.05 (μm) and 0.10 (μm)

Not bad: the standard deviation between 0.10 (μm) and 0.20 (μm)

Poor: the standard deviation exceeding 0.20 (μm)

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A toner containing at least binder resin and colorant, the toner comprising a particle which has an outline having one or more and three or less bending points in its projection image on a plane.

2. The toner of claim 1, wherein 0.35≦(S₂/S₁)+(S₃/S₁) is satisfied where S₁, S₂, and S₃ represent areas in descending order, the areas being each enclosed by a straight line connecting the bending points and the outline of the projection image of the particle projected on the plane.

3. The toner of claim 1, wherein the toner contains 60% by number or more of the particle which has the outline having one or more and three or less bending points in its projection image projected on the plane.

4. The toner of claim 1, wherein coefficients a₀, a₂, and b₂ in the following expression (1) satisfy 0.15≦a₀⁻¹(a₂²+b₂²)^{1/2}≦0.38 in a Fourier series expansion of a waveform of plots of distance f(x)(μm) from a center of gravity of the outline to the outline at a given angle x (rad) from the center of gravity of the outline:
f(x)=a₀/2+Σ(aₙ cos [nx]+bₙ sin [nx]) (1)

5. The toner of claim 4, wherein the coefficients a₀ and a₂ in the above expression (1) satisfy 0.15≦a₂/a₀≦0.35 in a Fourier series expansion of a waveform of plots of distance f(x)(μm) from the center of gravity of the outline to the outline at a given angle x (rad) where a distance from the center of gravity of the outline to the outline is the longest at zero angle (rad).

6. The toner of claim 1, wherein coefficients a₀, a₃, and b₃ in the above expression (1) satisfy 0.08≦a₀⁻¹(a₃²+b₃²)^{1/2}≦0.22 in a Fourier series expansion of a waveform of plots of distance f(x)(μm) from a center of gravity of the outline to the outline at a given angle x (rad) from the center of gravity of the outline.

7. The toner of claim 6, wherein the coefficients a₀ and a₃ in the above expression (1) satisfy 0.08≦a₃/a₀≦0.20 in a Fourier series expansion of a waveform of plots of distance f(x) (μm) from the center of gravity of the outline to the outline at a given angle x (rad) where a distance from the center of gravity of the outline to the outline is the longest at zero angle (rad).

8. The toner of claim 1, wherein coefficients a₀, a₂, and b₃ in the above expression (1) satisfy 0.10≦a₀⁻¹(a₂²+b₃²)^{1/2}≦0.38 in a Fourier series expansion of a waveform of plots of distance f(x)(μm) from a center of gravity of the outline to the outline at a given angle x (rad) from the center of gravity of the outline.

9. The toner of claim 8, wherein coefficients a₀, a₂, and b₁ in the above expression (1) satisfy 0.05≦a₂/a₀≦0.15 and 0.25≦(a₂/a₀+b₁/a₀)≦0.50 in a Fourier series expansion of a waveform of plots of distance f(x)(μm) from the center of gravity of the outline to the outline at a given angle x (rad) where a distance from an intersection of a major axis with a minor axis of the outline to the outline is the longest at zero angle (rad).

10. The toner of claim 1, wherein coefficients a₀, a₂, and a₃ in the above expression (1) satisfy 0.10≦a₀⁻¹(a₂²+a₃²)^{1/2}≦0.38 in a Fourier series expansion of a waveform of plots of distance f(x)(μm) from a center of gravity of the outline to the outline at a given angle x (rad) from the center of gravity of the outline.

11. The toner of claim 1, wherein coefficients a₀, a₂, and b₄ in the above expression (1) satisfy 0.09≦a₀⁻¹(a₂²+b₄²)^{1/2}≦0.38 in a Fourier series expansion of a waveform of plots of distance f(x)(μm) from a center of gravity of the outline to the outline at a given angle x (rad) from the center of gravity of the outline.

12. The toner of claim 1, wherein the toner is formed of aggregated particles into which at least fine resin particles and fine colorant particles aggregate, and has a volume average particle size of 3 μm or more and 10 μm or less.

13. The toner of claim 1, wherein the toner is formed of aggregated particles into which fine coloring resin particles containing at least colorant and binder resin aggregate, and has a volume average particle size of 3 μm or more and 10 μm or less.

14. The toner of claim 13, wherein the fine coloring resin particles have a volume average particle size of 0.2 μm or more 3.0 μm or less.

15. The toner of claim 13, wherein the fine coloring resin particles are obtained by a high-pressure homogenizer method.

16. A method of manufacturing the toner of claim 1, comprising the steps of:
preparing aqueous slurry having fine coloring resin particles dispersed therein by a high-pressure homogenizer method, the fine coloring resin particles containing the above colorant and the above binder resin; and
aggregating the fine coloring resin particles in the aqueous slurry.

17. The method of claim 16, wherein the fine coloring resin particles in the aqueous slurry aggregate in a granulating device including an agitating container storing the aqueous slurry and an agitating part being disposed inside the agitating container and agitating the aqueous slurry.

18. A two-component developer containing the toner of claim 1 and a carrier.

19. A developing device performing development by use of developer containing the toner of claim 1 or the two-component developer of claim 18.

20. An image forming apparatus having the developing device of claim 19.
